(19) United States
(12) Patent Application Publication
(10) Pub. No.: US 2019/0392296 A1
(43) Pub. Date: Dec. 26, 2019

(54) HARDWARE AGNOSTIC DEEP NEURAL NETWORK COMPILER

(71) Applicants: John Brady, Celbridge (IE); Marco Mecchia, Maynooth (IE); Patrick F. Doyle, Hillsboro, OR (US); Stanislaw Jan Maciag, Dublin (IE)

(72) Inventors: John Brady, Celbridge (IE); Marco Mecchia, Maynooth (IE); Patrick F. Doyle, Hillsboro, OR (US); Stanislaw Jan Maciag, Dublin (IE)

(21) Appl. No.: 16/457,851

(22) Filed: Jun. 28, 2019

(51) Int. Cl. G06N 3/063

(52) U.S. Cl. CPC G06N 3/063

(57) ABSTRACT

A compiler receives a graph describing a neural network and accesses data to describe a target computing device to implement the neural network. The compiler generates an intermediate representation from the graph and the data, where the intermediate representation includes an operator model, a data model, and a control model. The compiler generates a binary executable using each of the operator model, data model, and control model of the intermediate representation.

### TECHNICAL FIELD

This disclosure relates in general to the field of computer systems and, more particularly, to compilers for machine learning computing systems.

### BACKGROUND

Machine learning models are models, which may be implemented by computing systems to receive an input and generate an output (e.g., a predicted output) based on the received input. Some machine learning models are parametric models and generate the output based on the received input and on values of the parameters of the model. Machine learning models may also include deep learning models that employ multiple layers of models to generate an output for a received input. For example, a deep neural network is a deep machine learning model that includes an output layer and one or more hidden layers that each apply a non-linear transformation to a received input to generate an output. Some neural networks are recurrent neural networks. A recurrent neural network is a neural network that receives an input sequence and generates an output sequence from the input sequence. In particular, a recurrent neural network uses some or all of the internal state of the network after processing a previous input in the input sequence in generating an output from the current input in the input sequence. Specialized computing systems have been developed to more efficiently and effectively implement and use such machine learning models.

### BRIEF DESCRIPTION OF THE DRAWINGS

FIG. 1 is a simplified block diagram of an example compiler configured for use with deep learning computing systems.

FIG. 2 is a simplified block diagram of an example electronic device that includes a machine learning device in accordance with some embodiments.

FIG. 3 is a simplified block diagram of an example machine learning device in accordance with some embodiments.

FIG. 4 is a block diagram illustrating an example an improved memory subsystem in accordance with some embodiments.

FIG. 5 is a block diagram of an example hardware accelerator device in accordance with some embodiments.

FIG. 6 is a block diagram illustrating use of memory resources by example processor elements in an example hardware accelerator device in accordance with some embodiments.

FIG. 7 is a simplified block diagram of a subsystem of an example machine learning device in accordance with some embodiments.

FIG. 8 is a simplified block diagram illustrating an example processor a machine learning system.

FIG. 9 is a simplified flow diagram illustrating an example volumetric acceleration unit of an example processor device.

FIG. 10 is a simplified block diagram illustrating an example compiler and an example intermediate representation generated by the compiler.

FIG. 11A is a simplified block diagram of an example operation model of an example intermediate representation of a neural network graph.

FIG. 11B is a simplified block diagram of an example data model of an example intermediate representation of a neural network graph.

FIG. 11C is a simplified block diagram of an example control model of an example intermediate representation of a neural network graph.

FIG. 12 is a simplified block diagram of an example compiler.

FIG. 13 is a simplified block diagram of an example control model of an example intermediate representation.

FIG. 14 is a simplified block diagram illustrating memory allocation in an example compilation process.

FIGS. 15A-15B illustrate a flowchart showing an example compilation process performed by a compiler.

FIGS. 16A-16C are flowcharts illustrating example techniques for generating a binary executable using an example compiler.

FIG. 17 is a block diagram of an exemplary processor in accordance with one embodiment.

FIG. 18 is a block diagram of an exemplary computing system in accordance with one embodiment.

Like reference numbers and designations in the various drawings indicate like elements.

### DETAILED DESCRIPTION OF EXAMPLE EMBODIMENTS

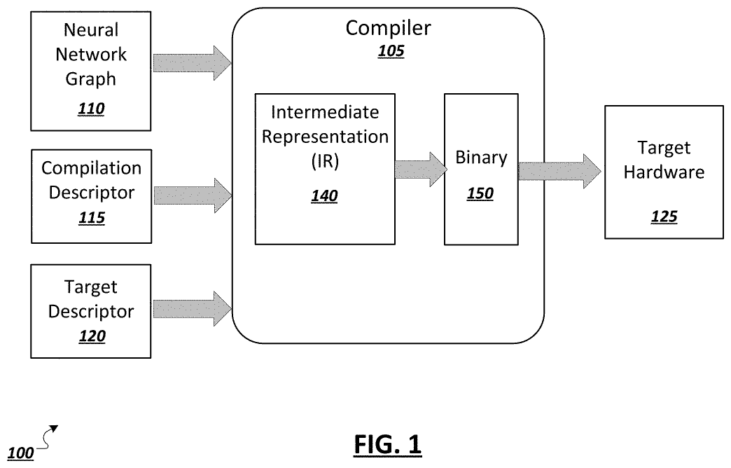

FIG. 1 is a simplified block diagram 100 showing an example compiler adapted to generate executable code from machine learning models in a manner adapted to optimize, or efficiently and intelligently utilize, the processing, memory, and interconnect resources of particular target machine learning hardware to be utilized in consuming and executing the machine learning model. For instance, a machine learning model, such as a graph definition 110 of an example neural network model (or other deep learning model) may be provided as an input for consumption by an example neural network compiler 105. Compilation descriptor data 115 may be provided to indicate one or more compilation sweeps to be performed based on attributes of one or both of the neural network model and/or the underlying hardware, as well as target descriptor data 120 to describe attributes of a target hardware processing device 125, which is targeted for executing the code to be generated by the compiler 105 from the graph definition 110. In some implementations, the hardware processing device 125 may be a parallel processing device, with multiple processing elements utilizing shared memory, where heterogenous technologies may be employed between the processing elements and/or shared memory elements utilized within the device 125. The compiler 125 may utilize these inputs to generate an intermediate representation (IR) 140, which includes multiple models 145 to represent the manageable resources provided by processing device 125. Such resources may include memory resources 130 and computation resources 135 (among other resources, such as communication or interconnect resources). Specific models 145 within the IR 140 may provide views of the memory resources 130 (e.g., through a data model) and computation resources 135 (e.g., a control model), among other example models provided within the generated IR to provide views for use in generating, through a set of compilation passes, code 150 (e.g., a binary), which is generated automatically by the compiler 105 as code optimized to the architecture and resources of the processing device 125.

Traditionally, general purpose compilers, such as GCC and LVMM compliers, have proved ill-suited to generating code for deep-learning applications involving dense and sparse linear algebraic operations. Further, as specialized hardware is increasingly developed and utilized to handle machine learning applications, the assumptions underlying traditional compilers may no longer be valid, further making such compilers poor candidates for use in machine learning applications. As a result, manual coding and optimization (as performed and implemented manually by human engineers) is often relied upon to implement machine learning systems, as such “handwritten” assembly code is generally regarded as surpassing the performance of code that is output by general-purpose compilers. For instance, some of the example issues and limitations of example general purpose compilers may include designs assuming that the code is being compiled for a single, synchronous compute unit or multiple devices with particular forms of parallelism and shared memory capabilities. As another example, general-purpose compilers may be configured for scale or vector instructions sets, and may be unable to map computations programs onto broader types of instructions like matrix multiplication. Additionally, general-purpose compilers may be built to assume a particular form of memory hierarchy, with a large main memory accessible by the CPU and a cache hierarchy on the chip that is managed completely by hardware, among other features, which limit the ability of such traditional compilers to handle and optimize workloads involved in modern (and evolving) machine learning applications.

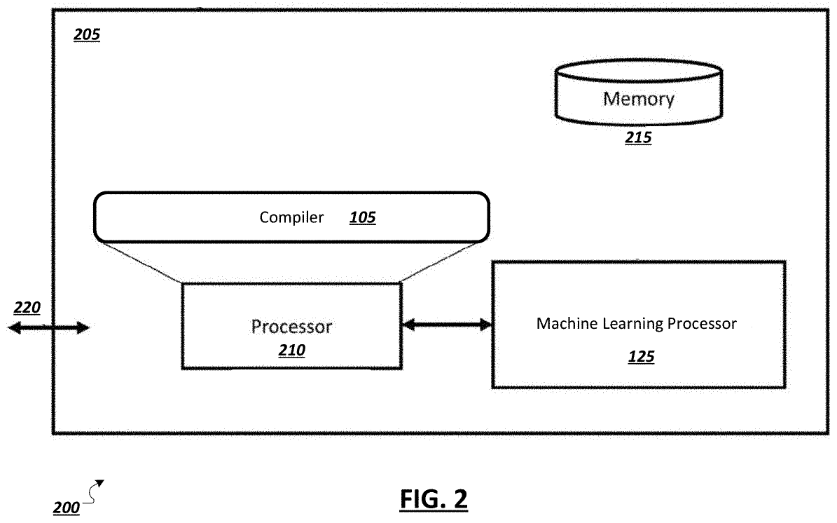

Turning to FIG. 2, a simplified block diagram 200 is shown of an example computing system 205 configured for handling machine learning applications. For instance, the computing system may be embodied as one or more devices (e.g., on one or more packages or dies) utilize a machine learning processing device 125, such as vision processing unit (VPU) or other parallel processing device, configured to effectively execute operations associated with deep learning applications. The computing system 205, in this example, may include a general-purpose processing device 210 (e.g., a CPU) with one or more cores, one or more memory elements 215, and one or more one or more interfaces 220 together with one or more machine learning processor devices (e.g., 125).

In some implementations, an example system 205 may have memory 215 such as a computer readable medium, flash memory, a magnetic disk drive, an optical drive, a programmable read-only memory (PROM), and/or a read-only memory (ROM). The system 205 may be configured with one or more processors 210 that process instructions and run software that may be stored in memory 215. The processor 205 can also communicate with the memory 215 and interfaces 220 to communicate with other devices. The processor 210 can be any applicable processor such as a system-on-a-chip that combines a CPU, an application processor, and flash memory, or a reduced instruction set computing (RISC) processor.

In some embodiments, an example compiler (e.g., 105), such as an example neural network compiler such as discussed herein, as well as other components, may be implemented in software stored in memory 215, and operate on the processor 210. The memory 215 can be a non-transitory computer readable medium, flash memory, a magnetic disk drive, an optical drive, a programmable read-only memory (PROM), a read-only memory (ROM), or any other memory or combination of memories. The software can run on a processor capable of executing computer instructions or computer code. The processor might also be implemented in hardware using an application specific integrated circuit (ASIC), programmable logic array (PLA), field programmable gate array (FPGA), or any other integrated circuit. In some embodiments, the compiler 105 can be implemented in a separate computing device in communication with the system 205 over an interface (e.g., 220). For example, the compiler 105 can operate in a server in communication with the system 205, among other example implementations.

Interfaces (e.g., 220) of an example system may be implemented in hardware or software. The interfaces 220 can be used to receive both data and control information from the network as well as local sources, such as a remote control to a television. The electronic device can also provide a variety of user interfaces such as a keyboard, a touch screen, a trackball, a touch pad, and/or a mouse. The electronic device may also include speakers and a display device in some embodiments.

In some embodiments, a processing element in the machine learning processing device 125 can include an integrated chip capable of executing computer instructions or computer code. The processor might also be implemented in hardware using an application specific integrated circuit (ASIC), programmable logic array (PLA), field programmable gate array (FPGA), or any other integrated circuit. In some embodiments, the machine learning device 125 can be implemented as a system on chip (SOC). In other embodiments, one or more blocks in the parallel processing device can be implemented as a separate chip, and the parallel processing device can be packaged in a system in package (SIP). In some embodiments, the machine learning device 125 can be used in machine learning applications. In some cases, the features of an example machine learning device enabling the device's effectiveness in machine learning applications may also be used in other data processing applications. Indeed, an example machine learning device 125 may not be purpose-built exclusively or specifically for machine learning, but may instead be equipped with hardware to make the composite operations relating to machine learning (and potentially other, non-machine-learning applications) more efficient. For instance, an example machine learning device 125 may be implemented as a parallel processing device well-configured to also handle image processing applications, video processing applications, and other example applications. Example machine learning application may include applications such machine learning and classification based on sequence of images, objects or video and augmented reality applications, computer vision, autonomous navigation, and other applications.

In some implementations, an example system 205 may be implemented as a computer device, such as a personal computing device, mobile computing device, server computing system (e.g., a rack scale, blade server, or other server computer), among other examples. The system 205 may run an operating system such as Windows, Linux, iOS, Symbian OS, iPhone OS, Windows Mobile, Android, among other examples. Through such an operating system (or virtual machines or software containers implemented on the system), the system 205 may have the capability to run applications locally and/or communicate with applications that are provided by remote servers in the communications network. Such systems may be implemented in a variety of form factors and embodiments, such as smart televisions (TVs), video projectors, set-top boxes or set-top units, digital video recorders (DVR), computers, netbooks, laptops, tablet computers, wearable devices, Internet of Things (IoT) devices, and among other example implementations.

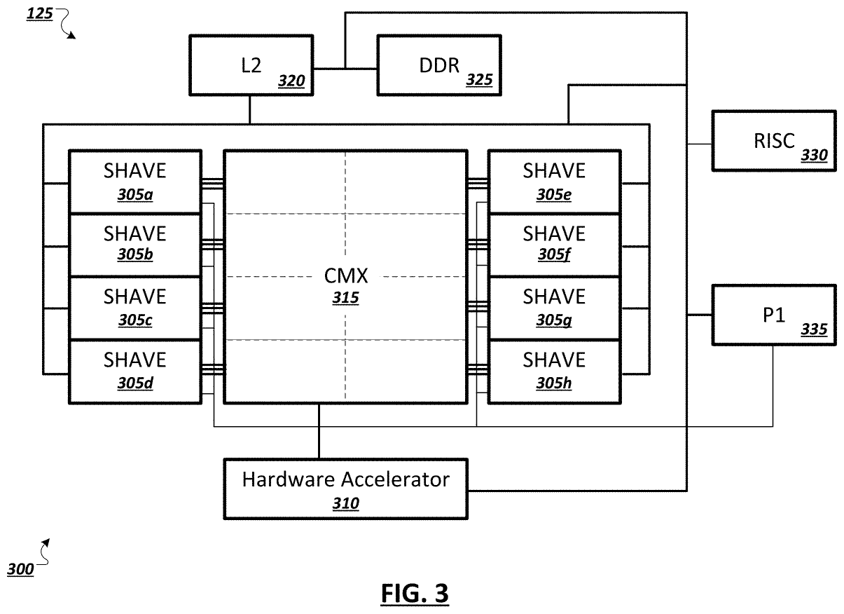

FIG. 3 is a simplified block diagram 300 of an example machine learning processing device 125, in accordance with some example implementations. In this particular example, a machine learning device 125 may implement a VPU that includes a set of special-purpose processors 305a-h, a machine learning accelerator 310, and non-standard memory hierarchy 315, and multiple types of memory (e.g., 320, 325). For instance, multiple processors 305a-h (e.g., Streaming Hybrid Architecture Vector Engine (SHAVE) processors) may share a multiport memory subsystem 315 in accordance with some embodiments. Such processors 305a-h may be implemented as proprietary or special-purpose processors with very long instruction word (VLIW) instruction sets, among other examples. The memory subsystem 315 may be implemented as a collection of memory slices, referred to herein as “connection matrix” (CMX) slices. CMX memory 315 may be implemented as fast, local memory (e.g., SDRAM) and can embody scratchpad memory usable by individual processors (e.g., 305a-h). Layer 2 (L2) cache 320 and DDR memory 325 may be further provided as more general-purpose, or system, memory, in this example. Further an example machine learning processing device may further include a reduced instruction set computer (RISC) element 330, as well as other processor devices (e.g., 335).

One or more hardware accelerator devices (e.g., 310) may be included in or coupled to the machine learning processing device. Such accelerator devices may be fixed-function hardware accelerators configured particularly to support matrix arithmetic, particular machine learning operations, or other specialized functions to enhance the overall capabilities of the machine learning processing device 125. In one example, the accelerator device may itself include a number of data processing units (DPUs), which may connect to and also make use of the memory subsystem 315, among other example features and components. In the example of FIG. 3, example memory subsystem 315 may include or define specific memory regions where specific tensor types are required to reside (e.g., populated, unpopulated, network input and output tensors). These and other examples features of an example machine learning processing device 125 may complicate the application of traditional compilers to such architectures.

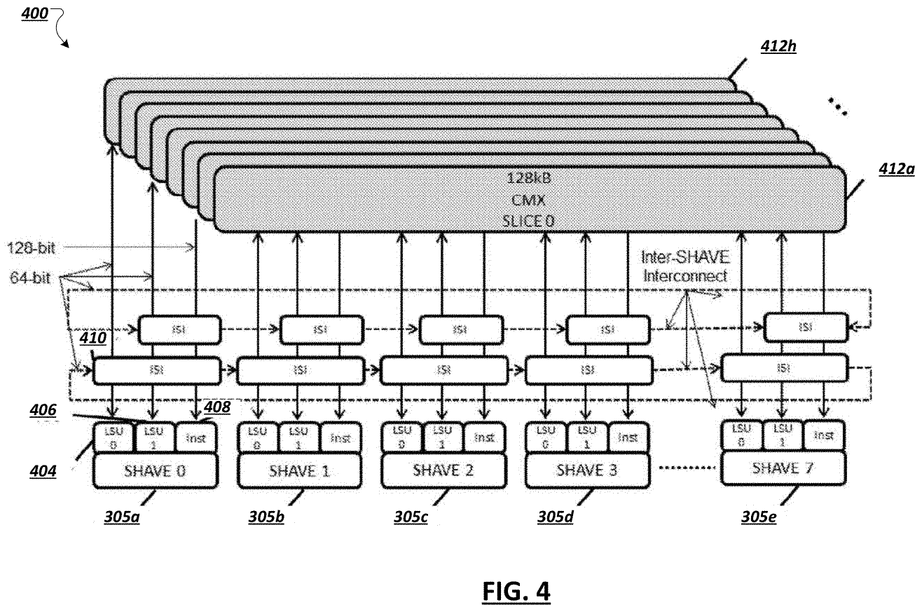

Turning to FIG. 4, a simplified block diagram 400 is shown illustrating a view of the memory interactions within an example machine learning processing device, such as discussed in the example of FIG. 3. Specifically, FIG. 4 shows a set of eight SHAVE processors (305a-h). In this example, each SHAVE processor can include two load store units (e.g., 404, 406 (LSU0, LSU1)) by which data may be loaded from and stored to CMX slices (e.g., 412a-h) of the memory subsystem memory 315. Each memory slice 412a-h may be associated with a corresponding one of SHAVE processors (305a-h). Further, each SHAVE processors (305a-h) can also include an instruction unit (e.g., 408) into which instructions may be loaded. A particular embodiment in which the processor includes a SHAVE, the SHAVE can include one or more of a reduced instruction set computer (RISC), a digital signal processor (DSP), a very long instruction word (VLIW), and/or a graphics processing unit (GPU). An example machine learning processing device may additional include an interconnection system 410 that couples the processors 305a-h and the memory slices 412a-h. The interconnection system 410 may be referred to as an inter-shave interconnect (ISI). The ISI can include a bus through which processors (e.g., 305a-h) can read or write data to any part of any one of the memory slices (e.g., 412a-h), among other example communications and transactions.

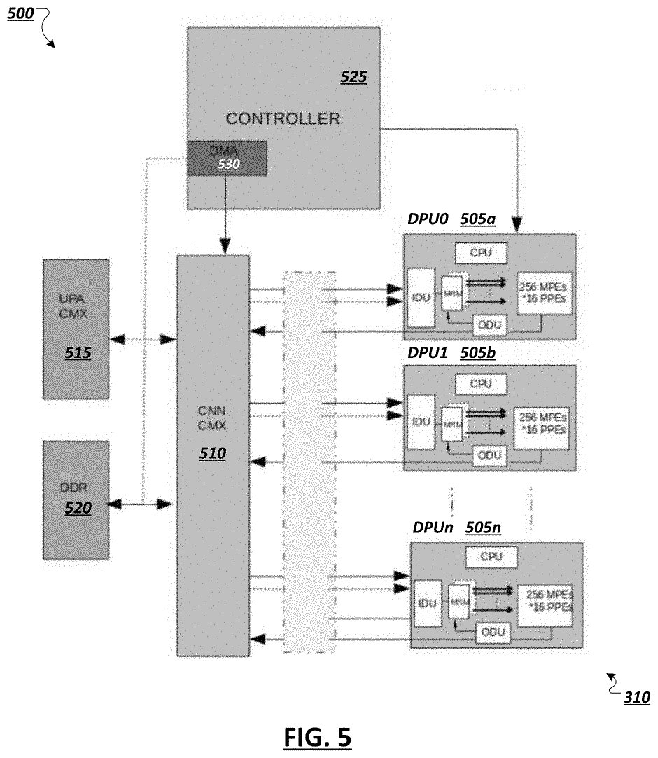

A variety of different hardware accelerator devices may be connected to and/or included within an example machine learning device. For instance, turning to FIG. 5, a simplified block diagram 500 is shown of an example implementation of a hardware accelerator 310. A hardware accelerator may be provided, such as circuitry of an example neural compute engine, which may be leveraged by the machine learning device to offload performance of one or more deep neural operations. A hardware accelerator may include a collection of data processing units (e.g., 505a-n), which may be connected to (and even include) a portion of memory 510 (e.g., CMX memory) of the memory hierarchy of the machine learning device (e.g., by one or more interconnects 515 coupling the hardware accelerator to the memory subsystem). For instance, in one example, an accelerator 310 may include 20 (or more) data processing units (DPUs) 505a-n connected to 4 MB of dedicated (e.g., internal) CMX memory for input activation and weight storage. Additional CMX memory (e.g., 515) may be provided off-chip (e.g., outside the accelerator device) as well as other off-chip memory 520 (e.g., implemented as DDR memory), among other examples. A memory controller (e.g., 525) may also be provided to govern how various components access elements of the memory subsystem. In some implementations, the memory controller 525 may include a direct memory access (DMA) engine (e.g., 530), among other example components.

In one example, a data processing unit (e.g., 505a-n) of an accelerator device may include a central processing unit (CPU). An input delivery unit (IDU) may access neural network data and provide the data to multi-read memory (MRM) of the DPU. A variety of processing elements may be provided to operate on the data. For instance, the processing elements may include a set of multiply accumulate (MAC) processing elements (e.g., MAC+pool) may be implemented through MAC processing elements (MPEs). Processing elements may additionally include a number of post processing elements (PPEs) (e.g., to provide flex compute). In the example of FIG. 5, a PPE may be provided for every 16 MPEs, although other rations and implementations may be provided in other examples. An example DPU may additionally include output delivery units (ODUs), for instance, to return results of the processing elements and perform various post-processing tasks on the results (e.g., data/tensor remapping, compression, etc.). Other (or additional) accelerator devices may be coupled and included in an example machine learning device, in other implementations.

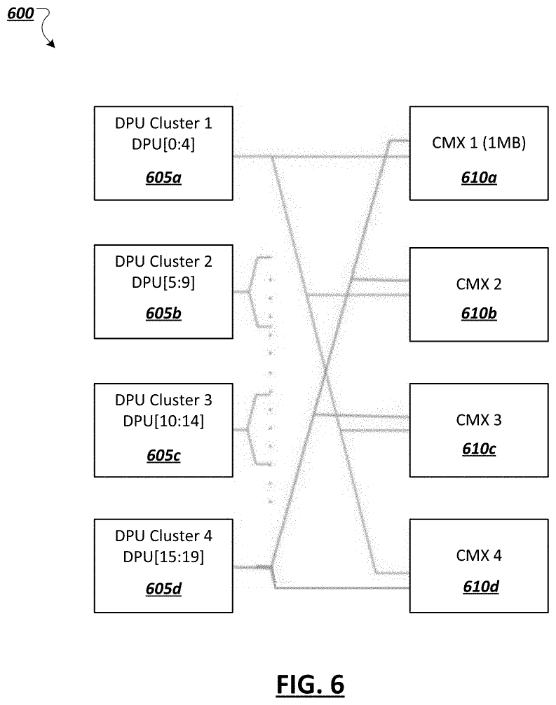

In some implementations, random access to CMX memory may not be possible due to a relatively high number of data processing units included in an example accelerator device. In one example, DPUs 505a-n may be organized into clusters (e.g., 4 clusters of 5 DPUs). Each cluster may be assigned preferred access (e.g., higher bandwidth, priority access, etc.) to a particular section of the CMX memory (e.g., 1 MB slice). In some implementations, a given cluster may additionally read/write to other CMX slices not assigned to the cluster, although the lower bandwidth afforded to this cluster may cause execution stalls and other example issues. For instance, turning to the simplified block diagram 600 of FIG. 6, an example is shown of example DPU clusters (e.g., 605a-d) mapped connected to example CMX slices (e.g., 610a-d). In some instances, as introduced above, individual clusters may be assigned preferential access to a respective one of the CMX slices, among other example implementations.

In systems employing accelerators such as illustrated in the example of FIG. 6, in order to achieve maximum performance (e.g., 8.2 TOPs/sec @800 MHz) all the DPUs should be fully utilized at all times to achieve maximum performance (e.g., an idle cycle may cost 5120 MAC operations). To achieve this, input activations and weights should be ready when a new layer is ready to be executed. This means that (1) layer weights should be loaded from DDR to CMX during the previous layer execution and (2) a layer output activation should be stored in the CMX in order to avoid unnecessary DMA transfers to DDR.

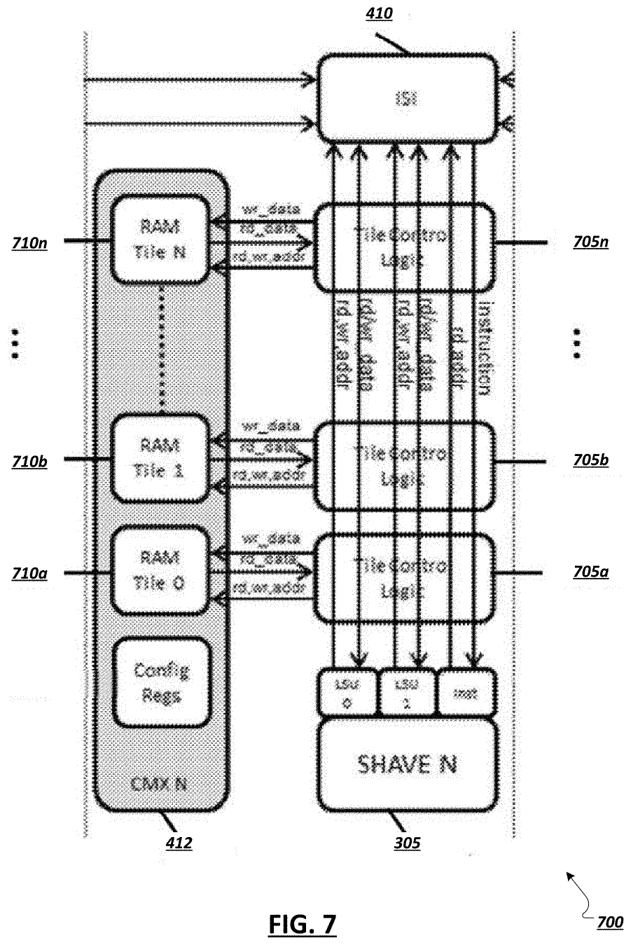

FIG. 7 is a simplified block diagram 700 illustrating a section of an example machine learning device (such as in the previous examples) in accordance with some embodiments. The section includes a single processor 305 (e.g., a SHAVE processor), a memory slice 412 associated with the single processor 305, interconnection system 410 that couples the processor 305 to one or more of the other memory slices of the machine learning device, and control logic (e.g., 705a-n) for arbitrating communication between a tile in the memory slice 412 and processors (e.g., 305). As illustrated in the example of FIG. 7, the processor 305 can be configured to directly access the memory slice 412 associated with the processor 305, while the processor 305 can access other memory slices (not shown) via the interconnection system 410. In some embodiments, each memory slice (e.g., 412) can include a plurality of RAM tiles or physical RAM blocks (e.g., 710a-n). For instance, a memory slice 412n having the size of 128 kB can include four 32 kB single-ported RAM tiles (e.g., physical RAM elements) organized as 4 k×32-bit words. In some embodiments, a tile can also be referred to as a logical RAM block. In some embodiment, a tile can include a single ported complementary metal-oxide-semiconductor (CMOS) RAM. The advantage of a single ported CMOS RAM is that it is generally available in most semiconductor processes. In other embodiments, a memory tile (e.g., 710a-n) can include a multi-ported CMOS RAM.

In some embodiments, each memory tile (e.g., 710a-n) can be associated with a respective tile control logic (e.g., 705a-n). The tile control logic (e.g., 705a-n) may be configured to receive requests from processors (e.g., 305) and provides access to the individual read and write-ports of the associated tile (e.g., 710a-n). For example, when a processing element (e.g., 305) wants to access data in a RAM tile (e.g., 710a), before the processing element 305 sends the memory data request to the RAM tile 710a directly, the processing element 305 can send a memory access request to the tile control logic 705a associated with the RAM tile 710a. The memory access request can include a memory address of data requested by the processing element 305. Subsequently, the tile control logic 705a can analyze the memory access request and determine whether the processing element 305 can access the requested memory. If the processing element 305 can access the requested memory, the tile control logic 705a can send an access grant message to the processing element 305, and subsequently, the processing element 305 can send a memory data request to the RAM tile 710a. As there is potential for simultaneous access by multiple processing elements, in some embodiments, the tile control logic (e.g., 705a-n) can include a clash detector, which is configured to detect an instance in which two or more processing elements, such as a processor or an accelerator, attempt to access any one of the tiles in a memory slice. The clash detector can monitor access to each tile (e.g., 710a-n) for an attempted simultaneous access. The clash detector can be configured to report to the runtime scheduler that an access clash has occurred and needs to be resolved, among other example features.

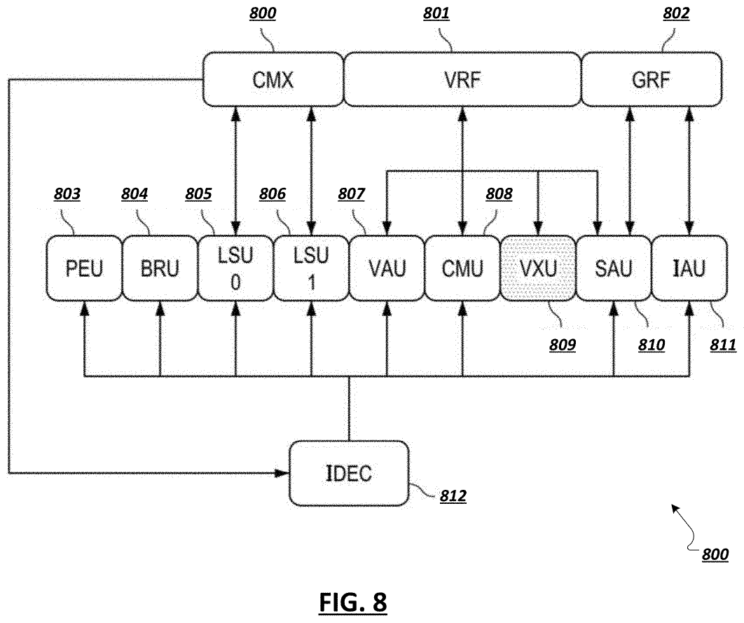

FIG. 8 shows a simplified block diagram illustrating an example implementation of a multislot vector processor 305 (e.g., a very long instruction word (VLIW) vector processor), such as a SHAVE processor, in accordance with some embodiments. In this example the vector processor may include multiple (e.g., 9) functional units (e.g., 803-811), which may be fed by a multi-ported memory system 800, backed up by a vector register file (VRF) 801 and general register file (GRF) 802. The processor contains an instruction decoder (IDEC) 812, which decodes instructions and generates control signals which control the functional units 803-811. The functional units 803-811 are the predicated execution unit (PEU) 803, branch and repeat unit (BRU) 804, load store port units (e.g., LSU0 805 and LSU1 806), a vector arithmetic unit (VAU) 807, scalar arithmetic unit (SAU) 810, compare and move unit (CMU) 808, integer arithmetic unit (IAU) 811, and a volumetric acceleration unit (VXU) 809. In this particular implementation, the VXU 809 may accelerate operations on volumetric data, including both storage/retrieval operations, logical operations, and arithmetic operations. While the VXU circuitry 809 is shown in the example of FIG. 8 as a unitary component, it should be appreciated that the functionality of the VXU (as well as an of the other functional units 803-811) may be distributed among multiple circuitry. Further, in some implementations, the functionality of the VXU 809 may be distributed, in some implementations, within one or more of the other functional units (e.g., 803-808, 810, 811) of the processor, among other example implementations

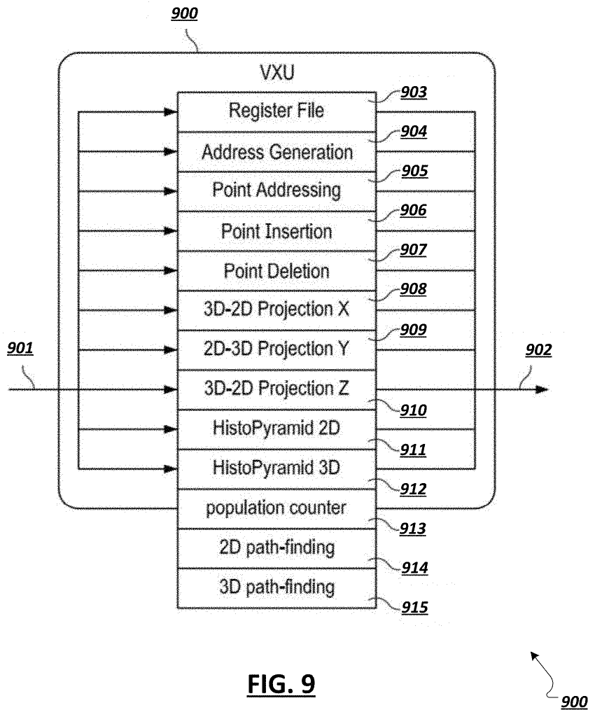

FIG. 9 is a simplified block diagram illustrating an example implementation of a VXU 900 in accordance with some embodiments. For instance, VXU 900 may provide at least one 64-bit input port 901 to accept inputs from either the vector register file or general register file. This input may be connected to a plurality of functional units including a register file 903, address generator 904, point addressing logic 905, point insertion logic 906, point deletion logic 907, 3D to 2D projection logic in X dimension 908, 3D to 2D projection logic in Y dimension 909, 3D to 2D projection logic in X dimension 910, 2D histogram pyramid generator 911, 3D histopyramid generator 912, population counter 913, 2D path-finding logic 914, 3D path-finding logic 915 and possibly additional functional units to operate on 64-bit unsigned integer volumetric bitmaps. The output from the block 902 can be written back to either the vector register file VRF or general register file GRF register files, among other example features.

Traditional compilers may be unable to generate a compiled binary for machine learning applications that effectively and efficiently utilizes the architectural elements of an example machine learning device, such as discussed in the examples of FIGS. 2-8. Further, in such machine learning devices, the compiled binary for the device may be serialized data and not machine code. Among other metadata, the compiled binary may specify the specific schedule in which operations are to be executed and the assigned memory locations to store tensors for use in subsequent operations thus optimizing inference (frames per second) and power performance, among other aspects of the machine learning device architecture.

Some machine-learning-specific compilers have been developed, but such compilers are also not without their failings. For instance, TensorFlow™'s Accelerated Linear Algebra™ (XLA compiler), for example, provides methods to retarget TensorFlow to non-CPU like hardware with or without an LLVM backend. However, such compilers may be limited in their applicability. For instance, the Google™ Tensor Processing Unit (TPU) has been developed as a custom ASIC specifically tailored to the TensorFlow framework. While existing machine-learning compilers may be used as the basis for non-TPU applications, such as by implementing a new backend to the XLA compiler (among other similar examples), such solutions have a number of example disadvantages and challenges. For instance, crafting a custom backend requires significant engineering time and resources, with the results in the hardware still limited by being tightly coupled with TensorFlow models. Further, XLA emits a vectorized LLVM intermediate representation (IR) for some nodes (such as dot), and relies on the LLVM vectorize for other nodes, however, this may not be compatible with some machine learning device architectures, such as the architectures described in the examples above. In some implementation, an example VPU, such as discussed above, may require an abstract compute resource interface to expose at compile time to identify the compute resource(s) that are available on the target VPU. As another example shortcoming, an XLA compiler (and other existing machine learning compilers) may not be able to guarantee optimal inference performance due to its assumption of a non-abstract memory type's interface, which may result in a non-optimal balance of in memory data locality thus reducing the full exploitation of compute parallelism. In some machine learning devices, an abstract memory type interface may be implemented. Further, to ensure full exploitation of compute parallelism, an abstract software-based memory allocation mechanism may be required that enables an application programming interface (API) for specifying which compiler algorithms to use to manage the allocation of memory. One such example is specifying that the compiler uses acyclic graph coloring memory allocation. As yet another example issue, TensorFlow, and other existing machine learning frameworks may be designed to operate using standard CPU/GPU-like memory architectures and not optimized memory architectures, such as discussed in the example memory architectures discussed in the example machine learning device systems above, among other example issues.

In one example, an improved compiler 105 may be implemented with a modular modern compiler infrastructure. In some cases, at least some of the features of the compiler 105 may be based on LLVM principles. As discussed above, utilizing TensorFlow-based compilers in some machine learning hardware device architectures and operators may be difficult/expensive and not scalable due to the limitations of developing a custom backend. An improved compiler, such as discussed can address these and other example issues.

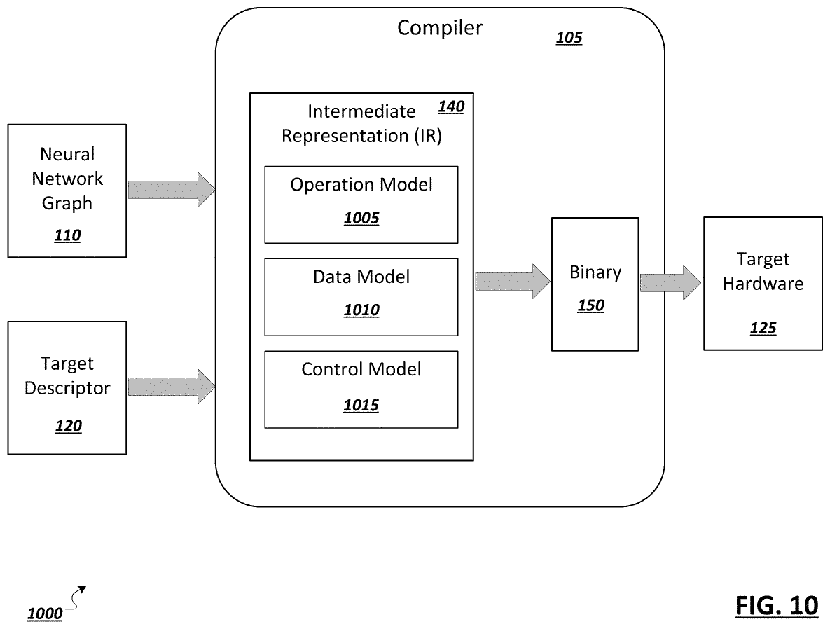

In some implementations, an improved compiler may be configured to consume a machine learning framework's (e.g., TensorFlow, Caffe™, etc.) representation (e.g., 110) of a Deep Neural Network (DNN), adapt and optimize it for a selected target (e.g., 125) and produce a binary executable (e.g., 150) corresponding to the selected target hardware 125 in a way that allows for compile time target specific optimizations. FIG. 10 is a simplified block diagram 1000 illustrating the generation of an example serialized binary 150 from a graph data structure 110 defining a trained neural network model for use in deep learning applications. The binary 150 may be generated to optimize the resources available at a particular target machine learning hardware device (e.g., 125). To produce such a binary 150, an improved compiler 105 may be provided that is implemented to optimize performance of deep learning applications. In some implementations, the compiler 105 may access the neural network model 110, together with information (e.g., target descriptor file 120) concerning the application and the target hardware 125 and generate an improved intermediate representation (IR) 140 from which the binary 150 is to be generated. In one example implementation, the intermediate representation 140 may be composed of a set of sub-models. In the particular example of FIG. 10, the models of the intermediate representation 140 may include an operator model 1005, a data model 1010, and a control model 1015. The intermediate representation 140 may also be provided with data (e.g., structural data 1020) describing attributes of the target hardware device (e.g., as extracted from an example target descriptor file 120), among other example sub-models and information.

When a neural network model is consumed from the front-end of an example compiler (e.g., 105), an intermediate representation (IR) 140 may be generated as discussed above. In one example, the IR 140 may be constructed by the compiler by parsing the neural network model 110 to identify the respective operations and data flow used to implement the neural network. Further, the compiler 105 may identify, from a target descriptor file 120, the memory and compute resources (and other resources (e.g., communication resources)) available on the target hardware device (e.g., and store this information in the IR (e.g., in structural model 1020)). A set of sub-models (e.g., 1005, 1010, 1015) may be generated and encapsulated within the intermediate representation 140 to provide a configurable representation of a mathematical structure (e.g., the computation model of the intermediate representation) of the neural network described in graph 110, for instance, in the form of one or more computation graphs from which a binary may be constructed, among other example implementations. The sub-models may each provide distinct views, but refer to the same underlying structure, the computation model of the intermediate representation. This may allow the overall complexity of the intermediate representation to be simplified to address compilation issues in isolation while sustaining the coherence of the logical space, which allows efficient processing of mutual relations between all types of entities considered.

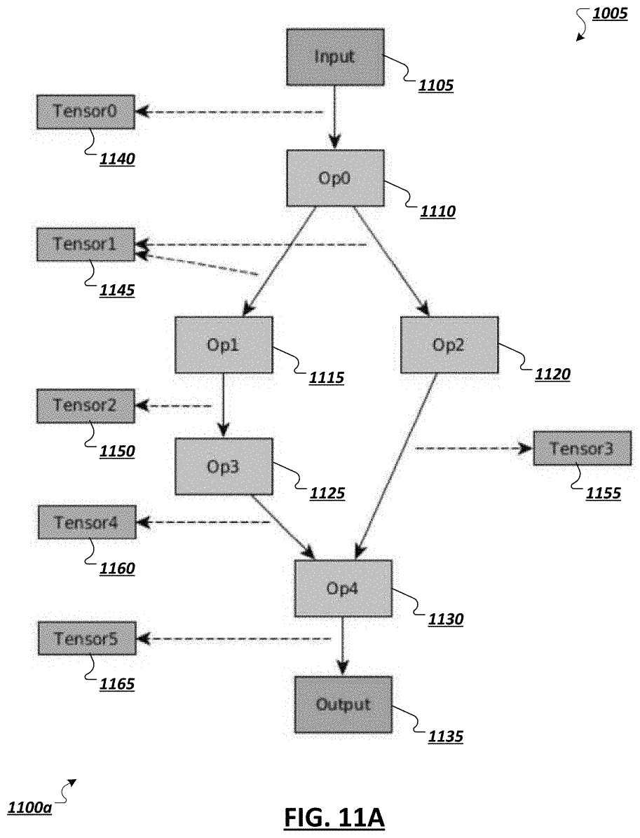

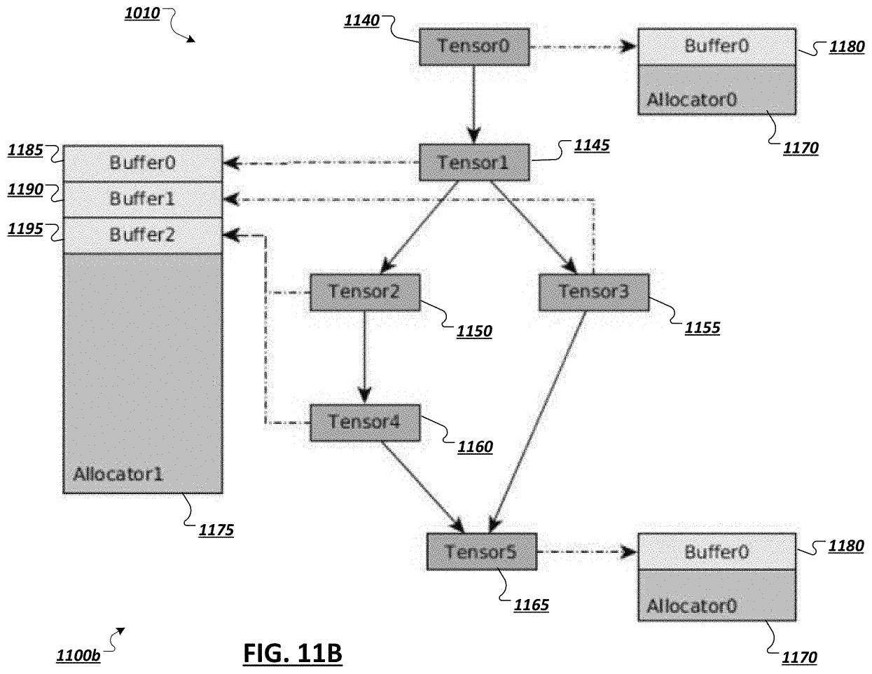

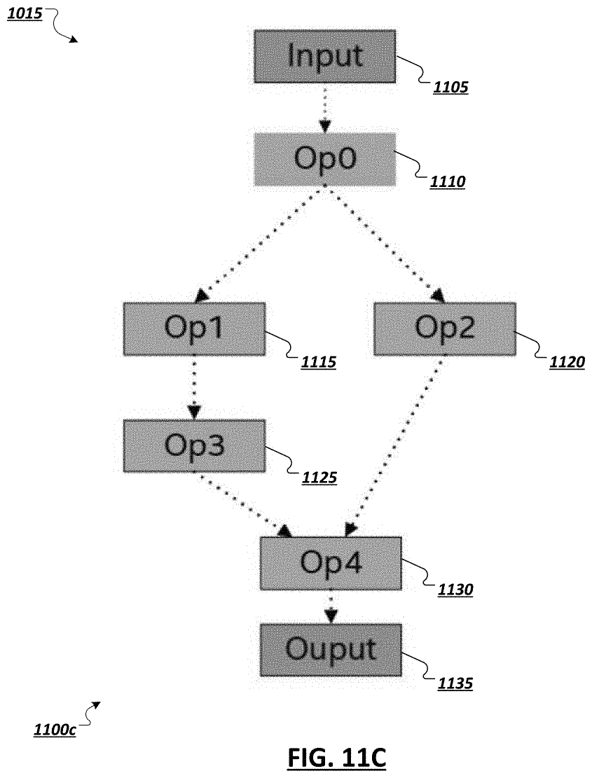

FIG. 11A is a simplified block diagram representing an example operator model 1005 in accordance with at least some embodiments. In this example (and the corresponding examples discussed in connection with FIGS. 11B-11C below), an example neural network is defined and described in an example graph data structure. The improved compiler may accept, as inputs, the graph data structure, together with a target descriptor describing attributes of a particular target device, and a compilation descriptor describing principles and compilation passes to be performed in connection with the compilation of the neural network into a binary for consumption by the target device. In this (simplified) example of a neural network, an input 1105 is to be received at the neural network and a collection of operations (e.g., 1110, 1115, 1120, 1125, 1130) are performed to implement the neural network layers (e.g., through multiply-accumulate (MACC) operations, perform activation functions, etc.) and generate an output 1135 (e.g., inference result, classification result, feature vector, etc.).

In some implementations, the operator model 1005 provides a configurable representation of a mathematical structure of the neural network (e.g., DNN) in the form of a computation graph. The operator model graph, in some implementations, may identify and model mathematical operations (or, simply, “operations”) serving as the building blocks of the neural network; tensors representing the products (e.g., multidimensional arrays) of the operations; and the data flows of the neural network, representing the data dependencies between operations that refer to tensors. The operator model 1005 may identify each of the operations (e.g., 1105-1135) and tensors (e.g., 1140, 1145, 1150, 1155, 1160, 1165) within this data flow. The tensors represent an anticipated result of at least one of the operations of the neural network. Accordingly, tensors may be associated with corresponding operations (e.g., operations (e.g., 1110) that will generate the corresponding tensor (e.g., 1150) as a result). In some implementations, an operator model (e.g., 1005) may be generated by mapping each of the nodes in the neural network graph 110 to a respective operation (e.g., 1105-1135) and defining a tensor for each edge in the neural network graph 110.

FIG. 11B is a simplified block diagram representing an example data model 1010 in accordance with at least some embodiments. A data model (e.g., 1010) may serve as a resource sub-model of the intermediate representation to model the manageable resources available in a target machine learning device, which may be used to implement the particular neural network (e.g., modeled by graph 110). Such resources may include memory resources representing the various types of memory of defined capacity used for the storage of tensors and accessible by various types of computation resources on the device, and computation (or “compute”) resources representing the hardware modules of the machine learning device that enable computation and processing of data or control of the execution. Resource sub-models of the intermediate representation may enable both types of manageable resources to have dedicated view that allows the compiler to generate an executable to efficiently and optimally access and manipulate them. In the case of a memory resources, the data model 1010 may be provided.

In the example of FIG. 11B, a data model 1010 may include a graph to represent the tensors (e.g., 1140-1165) determined for the neural network and may additional include memory allocator objects (e.g., 1170, 1175) for each memory resource of the target machine learning device. In some implementations, a target descriptor 120 file (e.g., implemented as JSON file) may be consumed by the compiler 105 and the available memory resources of the target machine (e.g., one or more off-chip memory blocks, one or a set of scratchpad memory blocks, among other memory resources) may be identified, and corresponding memory allocator objects may be instantiated. In the particular example of FIG. 11B, two memory resources have been detected in the particular target machine learning hardware, such as a local scratchpad memory resource and an off-chip DDR resource, among other potential examples. Accordingly, in the example of FIG. 11B, the compiler may instantiate two corresponding memory allocator objects (e.g., 1170 and 1175) respectively for each of the two identified memory resources of the target.

In some implementations, a memory allocator object may define a set of attributes to be determined for the corresponding memory resource as well as a set of methods, which may be called (e.g., by the compiler) to determine values for the attributes and populate these values in the memory allocator object. Memory allocator objects may enable a compiler capable of a flexible memory management approach for optimal inference performance in deep neural network applications. Each memory allocator object may manage the allocation of data buffers (e.g., 1180, 1185, 1190, 1195) for its respective type of memory resource (and memory region specified in the target descriptor file). This enables the precise location of every piece of data at any given stage in the execution process to be known at compilation time. This specialized memory management approach in the compiler, facilitated through these memory allocator objects, may serve as a key enabler for an improved compiler to generate executables that enable target hardware to achieve better inference performance than in traditional implementations, among other example benefits.

FIG. 11C is a simplified block diagram 1100c representing an example control model 1015 in accordance with at least some embodiments. The control model 1015 may also implement a portion of the resource sub-model of the intermediate representation. Specifically, the control model 1015 may be used to model computation resources. The control model 1015 may model the order and dependencies of the collection of operations determined to implement the neural network (e.g., in connection with the generation of the operator model). The ordering may be determined, not only from the nodes of the neural network graph, but also from the attributes and resource constraints of the target hardware system, as identified in a target descriptor file.

FIG. 11C shows a simplified example of a control model 1015 (corresponding to the example operator and data models of FIGS. 11A-11B). In this particular example, the hardware resource constraints of the identified example machine learning device are capable of facilitating the ordering and dependencies as natively described in the neural network graph. For instance, control model 1015 may define that operation 1110 is to begin after (and is dependent on) completion of operation 1105, that operation 1115 is to begin after (and is dependent on) completion of operation 1110, and that operations 1120 and 1125 are to begin after (and are each dependent on) completion of operation 1115. As operation 1125 is in a parallel branch as operations 1120 and 1130, operation 1125 is not dependent on operations 1120 or 1130 and operations 1120 and 1130 may be performed before, after, or in parallel with operation 1125, and so on. In other implementations, either due to the complexity and demands of the operations determined to implement a given neural network and/or due to the resource limitations of the selected target machine learning device (e.g., limited memory, compute, or communications resources), an example control model (e.g., 1015) may be developed (e.g., based on one or more compilation passes and information in the corresponding target descriptor file), which considers not only the native ordering expressed in the neural network graph, but also reflects the hardware resource limitations of the target hardware. For instance, due to resource constraints, additional dependencies may be determined for implementation of a neural network on particular target hardware, and these additional dependencies may also be described and modeled in the control model generated for such examples.

An example compiler utilizes the sub-models of the intermediate representation to perform a collection of compilation passes to generate an executable tuned to particular target hardware. Depending on the compilation pass, a particular one of the intermediate representation sub-models may be selected and used to perform the compilation pass. In general, the compilation process is divided into compilation passes that are functions over the intermediate representation's computation model. However, it should be appreciated that the scope of a single compilation pass is not restricted, but is usually oriented on solving an isolated task, such as assigning static populated tensor to constant-like memory or replacing sub-graph of operations with more efficient equivalents, among other examples. In some implementations, this compilation process transforms a generic, target agnostic entry form of the neural network graph model into representation appropriate for the target hardware. As part of that process, the intermediate representation is used to assign computation resources to operations (simultaneously with replacement of generic operations with target defined equivalents) and memory resource to tensors. Further, the control model may further enhance the intermediate representation to define the flow of execution, for instance, to enable a parallel execution of certain part of a deep neural network, among other example features.

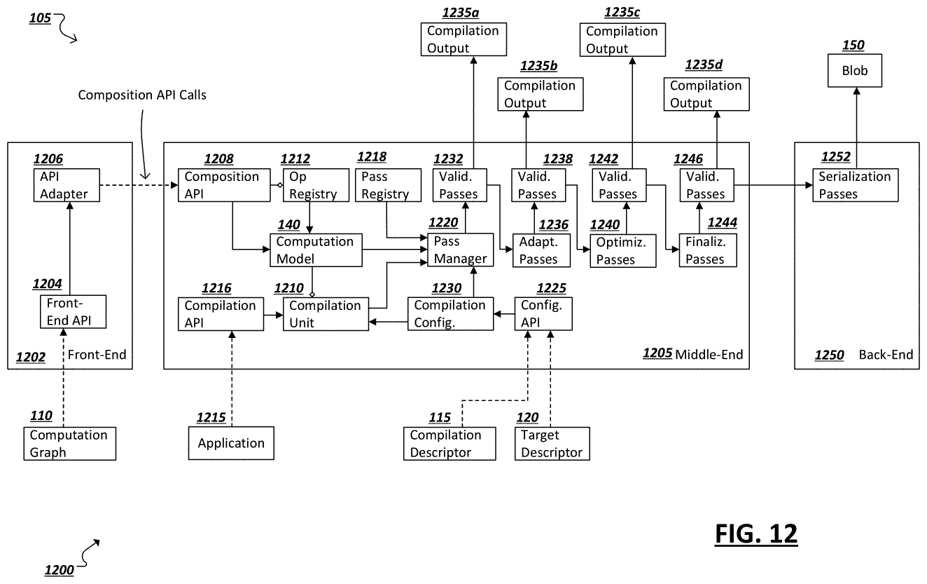

Turning to FIG. 12, a simplified block diagram 1200 is shown illustrating components and functionality of an example compiler 105, such as described in the improved embodiments discussed herein. The compiler 105, in this example, may include a front end 1202, a middle-end 1205, and a back end 1250. A compilation graph 110 describing a particular trained neural network may be received, in some implementations, at the front end (e.g., through front-end API 1204). The graph 110, in some instances, may be generated according to an open source platform (e.g., TensorFlow, Caffe, etc.). The front end may consume and parse the graph 110 and generate composition API calls (e.g., from API adapter 1206 to a composition API 1208) and initiate generation of an executable binary (e.g., 150) for the particular neural network using the compiler 105.

In some implementations, a composition API may be provided, which is configured to generate an intermediate representation, or “computation model” 140, for the particular neural network. In some instances, an operation registry 1212 may be provided to define, within the compiler, a number of operations of which the compiler 105 is familiar and that may correspond to nodes in example neural network graphs. The operation registry 1212 may be used to define how the compiler is to handle allocation of hardware resources in order to enable performance of the particular operation. In some cases, the operation registry 1212 may include a collection of operation definitions associated with the implementation of deep learning models.

In some instances, an example compiler may be provided, which includes a compilation API 1216 capable of interfacing with one or more external applications (e.g., 1215) (or, in some cases, an application provided in a suite of deep learning integrated development environment tools), where the application is configured to enable users to author and generate a graph of a particular neural network model, among other example implementations. In either instance, a corresponding intermediate representation may be generated for the graph. In some implementations, the intermediate representation may include an operator model, a data model (with memory allocators), and a control model, which may be used in connection with the performance of various compilation passes, such as discussed herein.

In some implementations, in addition to accepting a neural network graph at the compiler 105, additional inputs may be received to customize the configuration of the compiler 105 for a particular compilation project. For instance, as introduced above, a compilation descriptor file 115 may be provided as an input to indicate a set of supported compilation passes to be performed by the compiler in connection with the generation of particular code 150 to implement the particular neural network. The compilation descriptor may define a list of passes to be executed during the compilation. The entries on such a list and their order may be specific for both target platform and compilation objective, for instance to optimize for performance or optimize for size. Additionally, a target descriptor file 120 may be provided as input to specify attributes of a particular neural network computing device that is to implement the neural network and for which the executable code 150 is to be tuned or optimized. In some implementations, a configuration API 1225 may receive the compilation descriptor 115 and target descriptor 120 and may extract information from the files 115, 120 to generate a compilation configuration 130, which may be used by a compilation unit 1210 and pass manager 1220 (or other components) responsible for orchestrating the compilation.

An example compilation unit (e.g., 1210) may be configured to manage the sequence of the compiler's 105 operation. The compilation unit 1210 may utilize the computation model 140 and compilation configuration 1230 to drive a particular compilation of a neural network to be tuned to a particular machine learning device. For instance, the compilation descriptor 115 may be parsed to determine a particular collection of compilation passes to perform. For instance, the compilation descriptor 115 may include a listing of compilation passes (e.g., selected by a user engineer or by a system) or may name a particular pre-defined collection, or package, of compilation passes, which the compiler may 105 recognize to determine which sub-set of supported compilation passes to perform in connection with a particular compilation project, among other example implementations. The compilation descriptor 115 may also define an order or dependencies of one or more compilation passes and the conditions for performing one or more the compilation passes, among other example information. A pass registry 1218 may be maintained in the compiler 105 and include logic to be selected and executed by the compiler to perform any one of a set of compilation passes supported by the compiler and listed in the compilation descriptor 115. In some implementations, the pass registry 1218 may be extendable, in that new and improved compilation passes may be added to or replace compilation passes included in the set of compilation passes of the pass registry 1218. A simplified a representation of an example compilation descriptor is provided as an illustrative example below:

```
{
  “initialize”: {
    “Singular”: [
      {
        “Number_of_ DPUs”: 5,
        “Number_of_ Clusters”:4,
        “mpe_mode”: “Matrix”,
      },
      “ComputeMemory”,
      “AssignUniqueOpld”,
    ]
  },
  “adapt”: {
    “Singular”: [
      “FuseBatchNorm”,
      “FuseBias”,
      “FuseRelu”,
      “FuseScale”,
    ]
  },
  “custom_adapt”: {
    “Singular”: [
      “StoreWorkloadStrategy”,
      “ConvertOpsToTasks”,
      “ComputeTensorsQuantParams”,
      “OrderConversion”,
      “AlignTaskWeights”,
      “GenerateSparsityMaps”,
      “GenerateWeightsTables”,
    ]
  },
  “dma”: {
    “Singular”: [
      “AddlnitialAndFinalDMATask”,
      “AddMemoryDeallocationTasks”,
    ]
  },
  “control_flows”: {
    “Singular”: [
      “DmaControlFlows”,
      “InputOutputControlFlows”,
        “TransitiveReduction”,
    ]
  },
  “finalize”: {
    “Singular”: [
      “MaxTopologicalCutAndPartialSerialisation”,
      “GenerateDPUWorkloads”,
      “ArrangeCustomExecution”,
      “AllocatelnputOutputTensorsCustom”,
      “AllocatePopulatedTensorsCustom”,
      “AllocateUnpopulatedTensorsCustom”,
      “TensorGraphColoring”,
      “RemoveDeallocationTasks”,
      “AddBarrierRefs”,
    “UpdateBarrierProducerConsumerCounts”,
      “PopulateWeightsTables”,
    ]
  },
  “validate”: {
    “Singular”: [
      “CheckTensors”
    ]
  },
  “serialize”: {
    “Singular”: [
      {
        “name”: “GenerateBinary”,
        “output”: “output/mcm.blob”
      },
    ]
  },
  “root”: {
    “Singular”: [
      “initialize”,
      “validate”,
      “adapt”,
      “custom_adapt”,
      “dma”,
      “control_flows”,
      “finalize”,
      “serialize”
    ],
    “Recurrent”: [
      “validate”
    ]
  }
}
```

In some implementations, a pass manager 1220 may interface with the compilation unit 1210 and initiate and orchestrate a series of compilation passes using the intermediate representation 140. (e.g., in accordance with a listing of compilation passes named in the compilation descriptor 115 and provided through the compilation configuration 130). In some implementation, the compilation passes may begin with one or more initial validation passes 1232 to validate the neural network graph for correctness before proceeding to a next stage of compilation passes. A corresponding validation pass (e.g., 1238, 1242, 1246) may be performed following the completion of a stage of (one or multiple) compilation passes (e.g., 1236, 1240, 1244). After each validation pass, a respective compilation output (e.g., 1235a-d) may be generated to document the results of the validation pass and provide system engineers and debuggers data to evaluate the progress and performance of the compilations. In some implementations, the compilation output data (e.g., 1235a-d) may include or be rendered into a graphical representation of the graph, as evaluated in the validation passes (e.g., and annotated to indicate any issues detected during the validation pass as well as identifying nodes and edges associated with these issues, among other example information).

In one example, compilation passes may be grouped into sets of compilation passes (e.g., of a particular type or category). Compilation passes may result in transformed versions of the intermediate representation graph, with validation passes confirming that these transformed, modified IR graphs are valid. In some instances, a compilation descriptor 120 may identify each of these groups of passes and specify the individual passes to be performed in each group or compilation stage. For instance, in one example, a set of one or more adaptation compilation passes 1236 may be defined and performed before other categories of compilation passes (e.g., optimization passes 1240 and/or finalization passes 1244, etc.). Adaptation passes 1236 may be compilation passes, which identify opportunities (independent of the target hardware) to modify the neural network graph itself and potentially simplify and optimize operation and data flows associated with the neural network, such as through fusion compilation passes (e.g., to combine two operations into a single operation) or replacement compilation passes (e.g., replace operations with functionally equivalent and more efficient or adaptable replacement operations), among other examples. Such compilation passes may identify hardware-agnostic opportunities, rooted in the underlying mathematics of the operations to be performed to implement the neural network, to generate a pared, more efficient version of the neural network (and reflect these modifications in a transformation of the intermediate representation graph).

Upon performing adaptation passes 1236 to perform hardware-agnostic optimizations of the underlying neural network graph, one or more corresponding validation passes (e.g., 1235b) to determine whether changes made to the graph through the adaptation passes 1236 result in errors, inconsistencies, conflicts, or other issues within the graph. Should a transformed version of the intermediate representation fail a validation pass, the compilation process may be interrupted (e.g., to allow for debugging) or terminated. A successful validation pass may enable further compilation pass stages (e.g., 1236, 1240, 1244, etc.) to proceed. Following the one or more adaptation passes 1236, the path manager 1220 may cause a set of optimization passes 1240 to be performed. Optimization passes 1240 may include compilation passes to determine the optimal computation resources of the target hardware (e.g., using an operator model of the intermediate representation) to perform each of the set of operations determined for the neural network (e.g., the pared set of operations resulting from adaptation passes 1236). Optimization passes 1240 may further include compilation passes to determine an optimize order to perform the operations (e.g., using the control model of the intermediate representation), among other examples.

Following the completion of optimization passes 1240, a further modified version of the computation model 140 may result and one or more corresponding validation passes (e.g., 1242) may be performed on the resulting model. Following successful completion of the optimization passes 1240, in some implementations, additional finalization compilation passes 1244 may be performed before generating the resulting executable 150. In some implementations, finalization passes 1244 may include compilation passes configured to optimally determine buffers for the various tensors defined in the model, as well as allocate and assign addresses to memory of the target hardware for these buffers and determine addressing of the allocated memory. Additional compilation passes may determine, based on an initial allocation of memory for the buffers, whether certain parallel data flows defined in the transformed computation graph will use more memory than is available on the target device, causing the compilation pass to potentially insert additional control edges to reduce parallel operations (e.g., accommodate memory resource limitations of the target device), among other examples. Memory allocator objects of a data model of the intermediate representation may be used during such memory allocation passes performed in finalization passes. Memory allocation passes may be performed, in some implementations, based on one or more specific memory allocation algorithms specified in the compilation descriptor 115. Further, in some implementations, the compiler may maintain temporary, context-defined states of all resources identified for particular target hardware. Such states may be stored in the form of computation stages, which allows to capture the time-variant characteristic of the computation. In particular, the stage data may be used by the compiler to ensure that no single resource is over-allocated in any moment of the execution, among other example features and benefits.

Following completion of the finalization passes 1244, a final validation pass 1246 may be performed, before sending the further modified computation model 140 to compiler backend 1250, where serialization passes 1252 are performed on the computation model 140 to generate a binary 150 capable of being executed by the target hardware to implement the neural network. The binary 150 may be a serial binary (e.g., a binary serially streamed out one byte at a time) optimized for implementing the neural network on the particular hardware device in accordance with the compilation descriptor 115 and target descriptor 120 files provided to the compiler 105.

As noted herein, a target descriptor file 120 (e.g., implemented as a JSON file or other human-readable and -editable file) may be utilized to specify the particular attributes of the hardware resources of a target machine learning device. In this manner, the improved compiler 105 may be configured to optimize a neural network executable for a wide variety of different machine learning devices and architectures, with respective target descriptor files being defined and used to configure the compiler to optimize to the specific attributes of the target device. Accordingly, different executables may be generated by the same compiler for the same neural network graph based on the respective target descriptor describing corresponding target hardware. Attributes of the target hardware may include attributes identifying the computation resources of the target hardware including identifying which computation resources of the target are capable of performing which types of operations (e.g., as understood by the compiler (from operation registry 1212)). The target descriptor file may additionally identify the various memory resources of the target hardware, including the types of memories, the size of these memories, affinities or connections between the memory blocks and computation resources, among other example information. A target descriptor 120 may additionally identify other information pertaining to the target hardware, including data types supported by the target hardware, interconnect or other communication resources of the target machine learning device, among other examples.

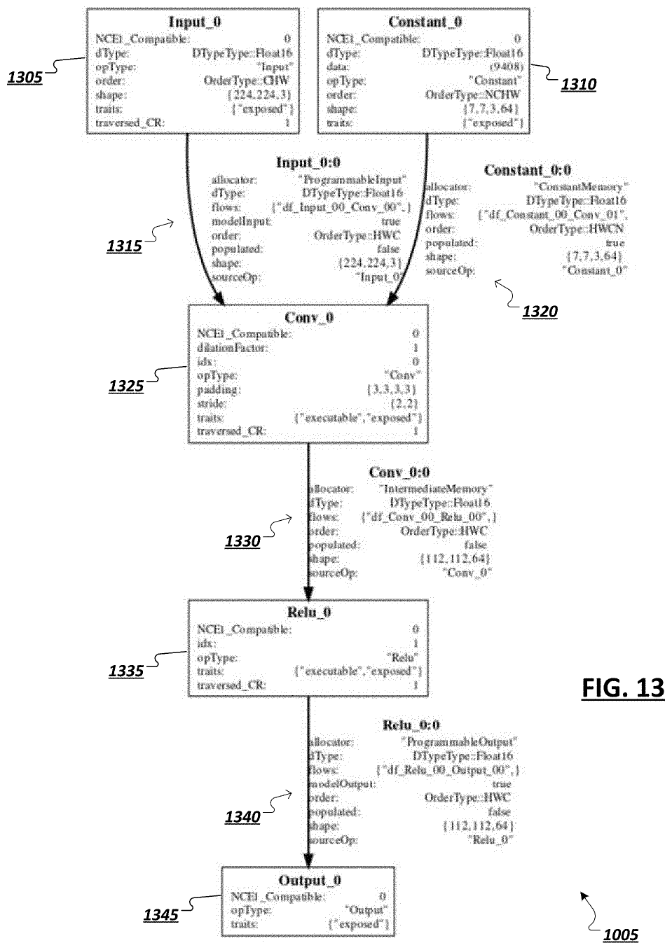

Turning to FIG. 13, a simplified block diagram 1300 is shown illustrating an example of an operator model 1005 of an intermediate representation of a particular neural network generated by an improved compiler. The example operator model 1005 may reflect the operator model as transformed by one or more compilation passes (e.g., adaptation and/or optimization passes). For instance, information concerning the operations and tensors described in the operator model 1005 may be determined and populated through such compilation passes, building on an initial version of the operator model 1005 as determined from the input neural network graph and/or target descriptor of a particular target machine learning device.

In the particular example of FIG. 13, a simplified neural network is modeled through the example operator model, the simplified neural network including two layers, a convolution layer and a ReLu layer. Two operations 1305, 1310 may be defined to correspond to accessing data to be input to the convolution layer and related convolution operation 1325. For instance, operation 1305 may be an input operation to load a sample (e.g., an image) in memory to be provided as an input to the neural network in a classification or inference. Operation 1310 may provide a constant value (e.g., the weights) to be used in a convolution with the sample loaded in operator 1305. The operator model 1005 may include fields to identify attributes of the operations (e.g., based on the type of the operation), including an identifier of the operation type. For instance, operations 1305, 1310 may each involve loading data into memory and the operator model 1005 may include attributes such as the type of the data that is to be loaded, the order in which the load is to be performed (e.g., channel→height→width (CHW)), the shape of the data (e.g., a 224×224 pixel image with 3 (e.g., RGB) channels (224×224×3)), among other example information. For operation 1310, where a constant is to be loaded, the operator model fields for the operation may identify the constants. For other operations, such as convolution operation 1325 and ReLu operation 1335, attributes for these operation types may likewise be defined and values populated using respective fields within the operator model to identify these attributes.

Continuing with the example of FIG. 13, an example operator model 1005 may also model the tensors (e.g., 1315, 1320, 1330, 1340) output by the operations. Output operations (e.g., 1345) may simply load the last generated tensor(s) into memory. An example operator model may also define fields for populating attributes determined (through one or more compilation passes) for each of the tensors. For instance, such tensor attribute fields may include fields to store attribute information such as the name of a corresponding memory allocator used to allocate memory for storage of the tensor on the target, the data type of the tensor, flows of the tensor, shape of the tensor, ordering for storage of the tensor, etc. This information may be utilized in other compilation passes (e.g., memory allocation passes) to reserve an appropriate amount of memory to store the tensor, among other example information. For instance, early compilation passes may be utilized to determine attributes of the operations and tensors (using the operator model of the intermediate representation). With this information, additional compilation passes may be performing (using the operator model and/or control model of the IR) to determine which operations are to be performed by which compute resources and in what order. With the assignment of compute resources and operation order set, together with the collection of tensor attribute information through preceding compilation passes, memory allocation passes may be performed (using a data model of the IR) to determine how best to allocate memory to enable fast and efficient use of the tensors to thereby optimize performance of the operations of the neural network by the particular target hardware.

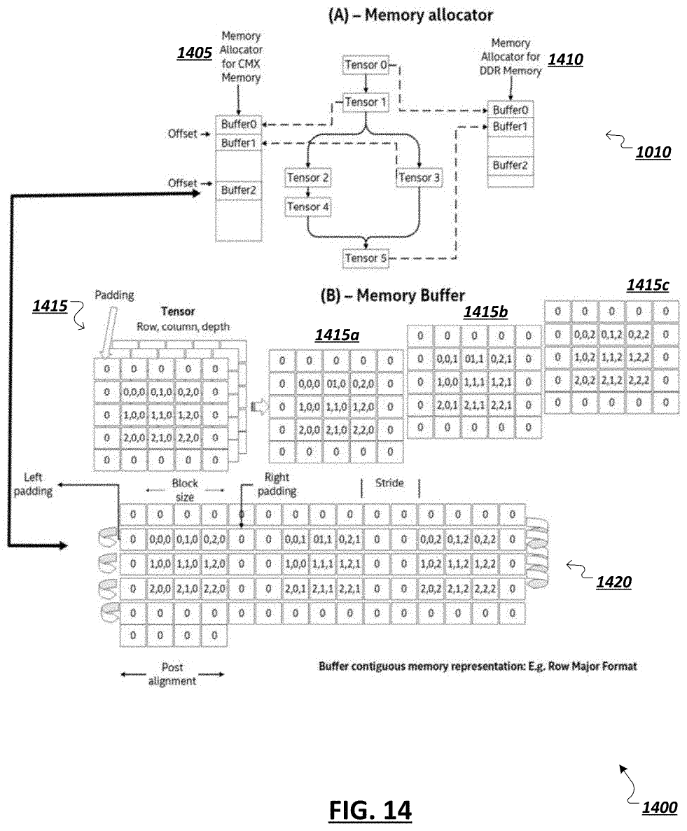

Turning to FIG. 14, a block diagram 1400 is shown illustrating an example memory allocation for an example tensor in accordance with at least some implementations. In the particular example of FIG. 14, a data model 1010 has been constructed by a compiler during generation of the intermediate representation of a particular neural network. The data model 1010 may be generated to create a number of memory allocator objects (e.g., 1405, 1410) for each of the memory resources of a target machine learning device (e.g., based on a target descriptor provided to the compiler and describing the device). In this (simplified) example, the memory resources of a particular target device include a CMX scratchpad memory resource and DDR off-chip memory. Memory allocator 1405 may be created to facilitate allocation of memory for buffers in the scratchpad memory and memory allocator 1410 may be similarly created to facilitate allocation of buffers in the off-chip memory.

The particular example of FIG. 14 illustrates allocation of memory within the scratchpad memory for a particular buffer (e.g., Buffer 2). Attributes of a particular one of the tensors 1415 (e.g., as described in the operator and/or data models of the intermediate representation) may be consulted to determine, first, which of the available memory resources would be most appropriate for use in storing the tensor. In this example, a particular tensor may be determined (e.g., through one or more compilation passes) to be used in a convolution operation by a subsequent operation performed by the same or nearby compute resource, and may thus be assigned to be stored in scratchpad memory (if available). One or more compilation passes may further utilize models of the intermediate representation to determine attributes of the tensor (e.g., its block size, padding used in the tensor, stride applied in the operation, whether the tensor (e.g., its constituent component matrices 1415a-c) should be stored in contiguous memory to optimize performance, among other example information. Determining this information can allow a size (e.g., 1420) of a buffer to be determined, which would be sufficient to store the tensor. Compilation passes may determine similar information for each of the tensors in the data model, and memory allocator objects (e.g., 1405, 1410) may extract this information and define buffers to identify the amount of memory to “reserve” or allocate for storage of each of the tensors during execution of the neural network. Memory allocation compilation passes may further act to affirmatively define address ranges in the target's memory where each buffer is to be implemented, and this information may be defined within the binary executable passed to and used by the target machine learning device.

As introduced above, an improved compiler may abstract the manageable resources of various target machine learning devices (e.g., Vision Processing Units (VPUs), TPUs, etc.), including the devices' computation resources that specific neural network operations can be executed upon and memory resources used to store tensors used in the neural network operations. For instance, target descriptors may be accepted and consumed by example compilers and the compiler may use the information within the target descriptor to flexibly tune the compilation process to the specific hardware architecture of potentially any one of multiple different devices. For instance, the target descriptor may specify which computations resources of a device are comparable performing which types of neural network operations (e.g., specifying that a convolution can be executed on either a SHAVE processor or a hardware accelerator). Example target descriptors may further specify the parameters of the operation (e.g., kernel size) that the particular computation resource can support (e.g., specifying that a particular hardware accelerator is limited to kernel sizes of 11×11). These resources are described in a Target Descriptor JSON file which is an input to the compilation.

An improved compiler may also utilize a modular software-based memory allocation approach to allocate physical memory to data structures (e.g., tensors in the graph) to specific memory regions described in the target descriptor file. This expresses how the computation resources (e.g., hardware accelerators, SHAVE processors, other processors) can access the data they need to compute on and enables code to be generated, which identifies, in optimized fashion, the precise location of every piece of data at any given stage in the execution process. Further, to ensure full exploitation of compute parallelism, the compiler may further provide an API for specifying which compiler algorithms (e.g., acyclic graph coloring memory allocation) to use to manage the allocation of memory, among other example features.

In some implementations, to enable consumption and use of target descriptors, an example compiler may be equipped with a software module integrated with the core of the compiler. Further, the compiler may provide its own API to allow users to define and modify the description of target platform as part of the compilation pipeline. For instance, the API (e.g., the DescribableTarget API) may provide methods to define memory and computation resources. For instance, the API (and target descriptor) define information for memory resources including the type of the memory resource, the size of the memory resource, byte alignment, word size, performance index, definition of tensors allocable, among other example properties. Information regarding computation resources may be defined, in the target descriptor, to include type of the computation resource, quantity or number of instances of the particular type of computation instance on the device, assignable operation types of the computation resource, translation map for the target specific operation type, restrictions of assignment because of the properties of the operation and other limitations of usage, among other example information. Using the target descriptor resource sub-models may be defined within intermediate representations generated by the compiler for various neural network models as part of the initialization of the compilation process.

In some implementations, the abstraction provided through a target descriptor file allows the compiler's software core to be logically decoupled from any particular target and effectively enables its easy reuse and modification. In fact, in some instances, the intermediate representation developed by the compiler may be at least partially defined during loading of the target descriptor, introducing extreme adaptability of the compiler (e.g., enabling compilation of custom configurations of machine learning devices and compilations involving purpose-built, special purpose, and proprietary machine learning devices), among other example benefits.

In some implementations, to provide an efficient mechanism to process information gathered in a particular target descriptor instance in an automated manner, while sustaining the assumption of loose restriction of its content, domain-specific meta-language may be defined for use in the target descriptor. Domain-specific meta-language may support efficient representation of complex conditional relations between structured operands, expressible in JSON format and integrated with the compiler core. Further, dynamic pass management may be supported by compilers compatible with the target descriptor, enabling custom passes to be included and controlled in the compilation.

Below is a pseudo-code representation of a portion of a simplified example target descriptor file in accordance with some generalized implementations:

```
{
  “target”: “device name”,
  “operations”:
  {
    “Convolution”: {
      “SHAVE PROCESSOR”: {
        “serial_description”: [
          “AttrradixX”,
          “Attr:radixY”,
          “Attr:strideX”
          “Attr:strideY”,
          “Attr:padX”,
          “Attr:padY”,
          “Attr:padStyle”,
          “Attr:dilation”,
        ]
      }
      “HARDWARE ACCELERATOR 1”: {
        “serial_description”: [
          “Attr:streamingMask”,
          “Attr:inputSize”,
          “Attr:outputSize”,
          “Attr:concatOffset”,
          “Attr:unloadCMX”,
          “Attr:overwriteInput”,
          “Attr:CMXSize”,
          “Attr:reluSHVAcc”,
          “Attr:shvNegSlope”,
          “Attr:shvPosSlope”,
          “Attr:desc_count”,
          “Attr:descriptors”,
        ]
      }
    },
  “dtype”:
  {
    “global”: “Float16”
  },
  “resources”:
  {
    “memory”:
    [
      {
        “name”: “DDR_Heap”,
        “alignment”: 64,
        “dataTypeSize”: 2,
        “size”: 1024000000
      },
      {
        “name”: “CMX_NN”,
        “alignment”: 64,
        “dataTypeSize”: 2,
        “size”: 1024000000
      },
      {
        “name”: “CMX_UPA”,
        “alignment”: 64,
        “dataTypeSize”: 2,
        “size”: 1024000000
      },
      {
        “name”: “DDR_BSS”,
        “alignment”: 64,
        “dataTypeSize”: 2,
        “size”: 1024000000
      },
      {
        “name”: “ProgrammableInput”,
        “alignment”: 64,
        “dataTypeSize”: 2,
        “size”: 1024000000
      },
      {
        “name”: “ProgrammableOutput”,
        “alignment”: 64,
        “dataTypeSize”: 2,
        “size”: 1024000000
      }
    ]
  }
}
```

In the above example, a target descriptor file may include a variety of information describing resources of an example target machine learning device. For instance, as shown in the example above, a target descriptor may identify a number of operations (e.g., corresponding to operations defined in the compiler's operation registry) and name the individual computation resources capable of performing the operation. For instance, in the example above, a Convolution operation is named in the target descriptor and two compute resources, “SHAVE PROCESSOR” and “HARDWARE ACCELERATOR” are named as computation resources capable of performing convolutions. Further, under each compute resource, attributes of the compute resource are specified, such as variables used by the resource to perform the operation, the number of instances of the compute resources on the target, the data types supported by the compute resources, among other example information. Further, memory resources are named in the above example, together with the specific attributes of each memory resource. For instance, for a name, alignment, data type size, and memory size attribute are specified for each memory resource, among other example information (e.g., the type of the memory technology). Further information may also be provided, including similar resource-specific attributes for computation resources and communication resources, the data precision of the target, data type(s) supported by the target, among other examples.

In some implementations, during compilation of a trained neural network into a serialized binary for inference, the compiler is to allocate specific physical memory addresses to data structures (tensors) in the memory regions specified in the target descriptor file. These memory regions may be dependent on the resources of the target device. The specific region of memory that a specific data structure is assigned to reside in is typically determined during compilation passes that determine the order of execution of operations and/or map the execution of each operation to a particular compute resource. In order to allocate specific physical memory addresses, memory allocator objects may be created by the compiler. Memory allocators may be implemented as high level software-based memory management objects in the compiler. A memory allocator object may be instantiated by the compiler for each memory type that is specified in the target descriptor. The memory allocator object may include methods callable to manage the allocation of buffers of data in the memory region that the respective memory allocator manages according to an algorithm that is specified in the compilation descriptor file. For example, in the example target descriptor above, six example memory regions are identified in the example target system (e.g., DDR_HEAP, CMX_NN, CMX_UPA, DDR_BSS, ProgrammableInput, ProgrammableOutput, etc.). Accordingly, in such an example, six corresponding memory allocator objects may be instantiated by the compiler based on receiving the target descriptor, each memory allocator responsible for allocating buffers of data in the corresponding one of the memory regions. In some cases, a hardware accelerator may require that the data that it reads be aligned to a certain boundary in memory, among other architectural considerations. Accordingly, a memory allocator manages specific memory buffers properties during allocation, which may be based on such architectural requirements. Table 2 illustrates example properties, which may be stored for memory resources in example target descriptors, which may be used by an IR data model of the compiler and in memory allocation compilation passes, among other example uses:

TABLE 2
Example Memory Resource Attributes in Target descriptors

| Properties | Description |
|---|---|
| Unique ID | A unique ID of the buffer |
| Offset | A value specifying the start location of the buffer relative |
| | to the beginning of the whole memory block managed by |
| | the allocator |
| Size | The size of the buffer, added to the offset represents the end |
| | location of the buffer managed by the allocator |
| Stride | An array of values specifying the ‘memory stride’ between |
| | consequent storage memory block owned by the buffer |
| Block size | A value specifying the size of storage memory blocks |
| | owned by the buffer |
| Block | A value specifying the number of storage memory blocks |
| number | owed by the buffer |
| Post | The length of trailing, a block of empty memory that is sued |
| alignment | for alignment |
| Left | Left side padding of the tensor stored in the buffer |
| padding | |
| Right | Right side padding of the tensor stored in the buffer |
| padding | |

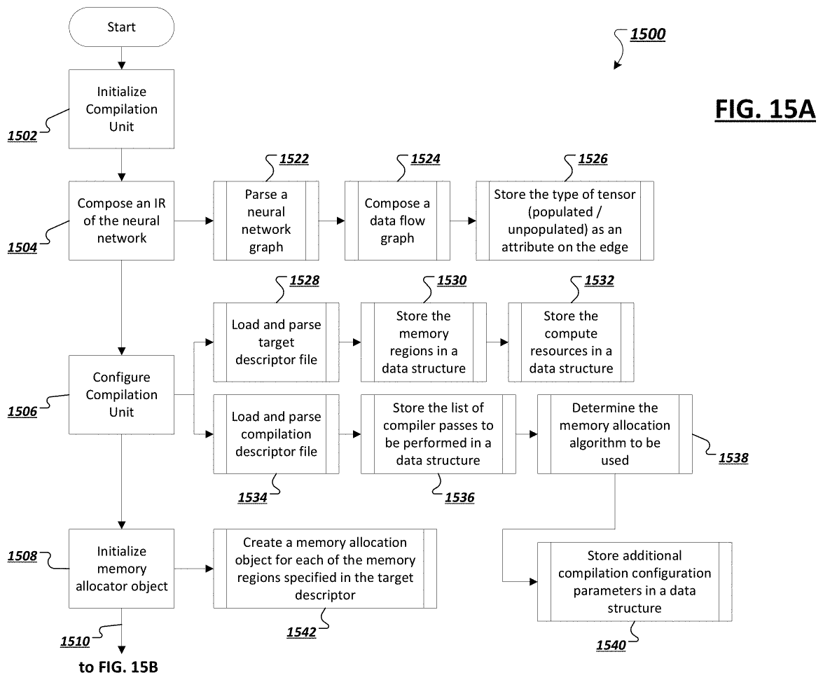

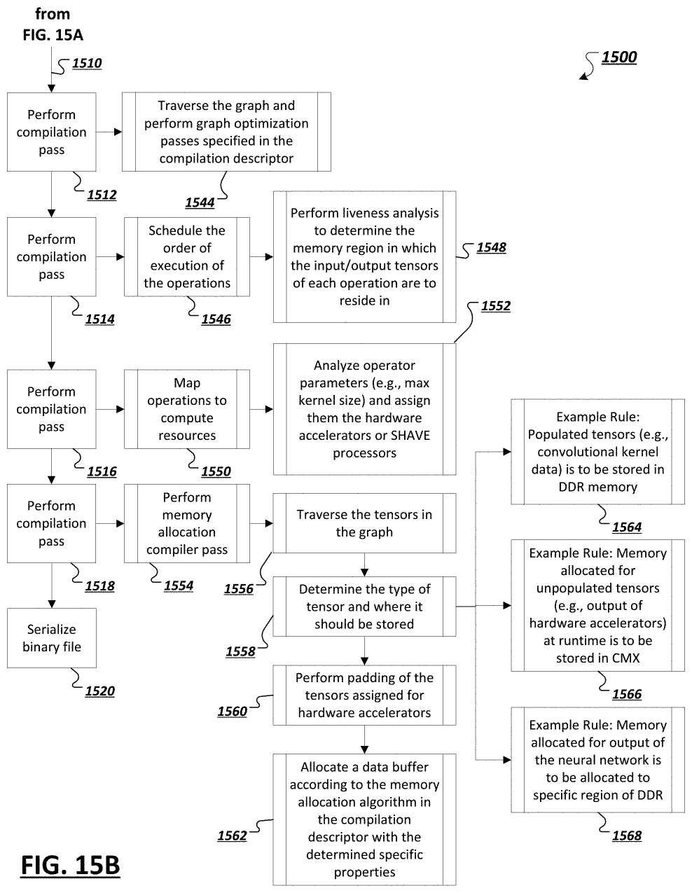

Turning to FIGS. 15A-15B, a flowchart 1500 is shown illustrating an example compilation using an improved compiler, such as discussed above. (Note that a top portion of the flowchart 1500 is illustrated in FIG. 15A, which continues into the bottom portion of the flowchart 1500 illustrated in FIG. 15B.) In one example implementation of an improved compiler, a compilation unit of the compiler may be initiated 1502, the compilation unit configured to manage the compilation of the deep neural network into a binary file for execution on a particular target device. An intermediate representation of the deep neural network may be composed 1504 by the compiler and a compilation unit may be configured 1506, for instance, using information in a target descriptor and compilation descriptor input to the compiler. A set of memory allocator objects may be instantiated and initialized 1508 based on information obtained for the particular target device (e.g., from a corresponding target descriptor file). The compilation flow continues (represented by arrow 1510), with the compiler performing a set of compilation passes (at 1512, 1514, 1516, 1518, etc.). Upon completion of the compilation passes, a transformed version of the neural network graph (transformed through the compilation passes 1512, 1514, 1516, 1518, etc.) may be used to generate 1520 binary file, which may be executed by the target device to implement the deep neural network.

Continuing with the example illustrated by flowchart 1500, composing an intermediate representation of the DNN may include (at 1522) parsing a neural network binary file (e.g., implemented as a graph data structure) at the compiler and composing an internal representation of the network with a direct translation of one operator to one or more nodes to generate sub-models of the intermediate representation. In some implementations, the sub-models may include an operator sub-model, a data sub-model, and a control sub-model, such as discussed herein. The operator sub-model may serve as a data flow graph and may be generated 1524 from the parsing. Further, tensors corresponding to the operations modeled in the operator graph may be determined 1526, as well as their type (e.g., populated (e.g., with a constant or other established input to the neural network) or unpopulated (e.g., with values to be determined as an output of a calculation of an operation)), and the tensors may be stored as an attribute of edges of the graph.

In some implementations, configuring 1506 the compilation unit of an example compiler may include loading and parsing a target descriptor file (at 1528) and loading and parsing a compilation descriptor file (at 1534). For the target descriptor file, memory regions identified in the target descriptor file may be stored 1530 in a data structure for future use by the compiler and, similarly, compute resources identified in the target descriptor may also be stored 1532 in a corresponding data structure for later use in the compilation. The list of compiler passes named in the compilation descriptor may also be stored 1536 in a data structure. The compilation descriptor may also identify to the compiler (at 1538) a memory allocation algorithm to be used during the compilation, as well as other additional compilation configuration parameters (e.g., the graph view to be generated as an output by the compiler (e.g., including an operator model, data model, and/or control model)), which may be stored 1540 in a data structure of the compiler to be applied during the compilation process.

Memory allocation objects created (at 1542) by the compiler to correspond to each of the identified memory regions of an example target device may be used, together with other models developed by the compiler (e.g., sub-models of the intermediate representation), to perform various compilation passes named in the compilation descriptor. In one example, compilation passes may be performed (at 1510), which include traversing 1544 the neural network graph input and performing hardware-agnostic graph optimization passes (e.g., as specified in the compilation descriptor), such as operation fusing or operation replacement, among other examples. The resulting version of the graph may be subject to further compilation passes (e.g., 1514), such as passes to schedule 1546 the order of execution of the operations and performing liveliness analyses 1548 to determine the memory region in which determined input/output tensors of each operation are reside in. Additional compilation passes (e.g., 1516) may be performed to map operations (at 1550) to the identified compute resources of the target hardware, for instance, by analyzing 1552 operator parameters (e.g. max kernel size) and assigning the operations to respective compute resources based on such operation parameters.

After initializing memory allocators and performing compilation passes to optimize the underlying neural network graph, determine an order of the operations, and mapping operations to respective compute resources, one or more additional compilation passes may be performed (at 1518) constituting memory allocation passes (at 1554). For instance, the tensors identified in the (transformed version of the) graph may be traversed 1556, and the type of each tensor (e.g., populated or unpopulated) may be identified 1558 and serve as the basis for determining where the tensor should be stored (e.g., in which general memory region of the target). For instance, populated tensors may be designated (e.g., according to the applied memory allocation algorithm) to be stored in DDR memory (e.g., 1564). Memory allocated for unpopulated tensors (e.g., output of hardware accelerators) at runtime may be designated for storage in local scratchpad memory (e.g., at 1566), and memory allocated for the output of the neural network may be allocated for storage in a specific region of DDR memory (e.g., at 1568), among other example rules. Additionally, any necessary padding may be performed 1560 to the tensor to align to a memory boundary, which may be required for operations determined to be performed on particular compute resources (e.g., some hardware accelerators). Next, data buffers may be allocated 1562 (e.g., using corresponding memory allocators) to specific memory regions according to the specified memory allocation algorithm, based on properties determined for the tensor. When all compilation passes are completed, a serialization pass may be performed (e.g., at 1520) to create a binary file that specifies the sequences of operations to be performed and the memory locations of each of the tensors, all tuned to the specific hardware of the target hardware.

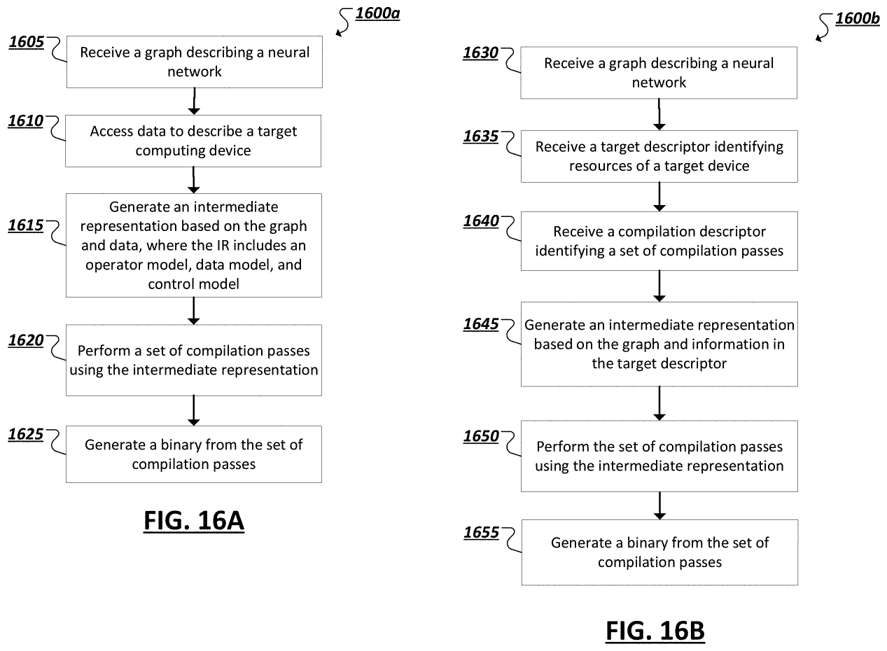

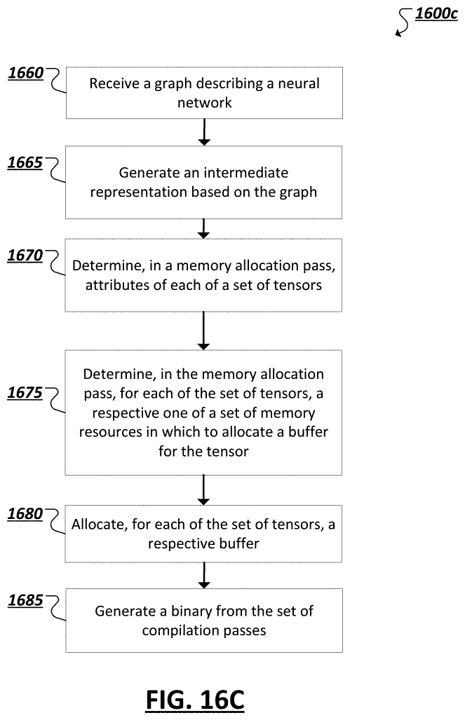

FIGS. 16A-16C are simplified flowcharts 1600a-c showing example techniques for generating binary executable to implement neural networks on target computing devices using improved compilers, such as discussed above. For instance, in the example of FIG. 16A, a graph may be received 1605 as an input to a compiler, the graph describing/modeling a particular neural network. Data may be accessed 1610 by the compiler, which describes attributes of a target computing device on which the neural network is to be implemented. An intermediate representation of the graph may be generated 1615 by the compiler based on the graph and the data, with the intermediate representation composed of sub-models, such as an operator model, data model, and control model. A collection of compilation passes may be performed 1620 using the intermediate representation. In some implementations, the sub-models may themselves be structured as graphs, and various compiler passes may utilize the sub-models (and perform graph-theory based analyses on the sub-model graphs) in order to optimize the underlying neural network graph and/or optimize utilization of hardware resources of the target computing device in implementing the neural network on the target. From the collection of compilation passes, a binary executable may be generated 1625, which is executable by the target computing device to implement the neural network.

In the example of FIG. 16B, a graph may be received 1630 as an input to a compiler, the graph describing/modeling a particular neural network. The compiler may be configured for optimization of the neural network on a particular target computing system by receiving 1635 a target descriptor file (e.g., a JSON file), which identifies the various hardware resources of the target system (e.g., memory resources, compute resources, communication resources, etc.), and by further receiving 1640 a compilation descriptor file (e.g., a JSON file), which identifies the listing of compilation passes to be performed. In some implementations, the compilation descriptor may additionally identify rules and specific algorithms to be used by one or more specific passes in the listing of compilations passes, among other example information. An intermediate representation may be generated 1645 by the compiler from based on the graph and information in the target descriptor. A set of compilation passes may be performed 1650 using the intermediate representation (and according to the compilation descriptor) and a binary executable may be generated 1655 based on the results of the completed set of compilation passes.

In the example of FIG. 16C, a graph may be received 1660 as an input to a compiler, the graph describing/modeling a particular neural network. An intermediate representation may be generated 1665 based on the graph. The intermediate representation may identify a set of operations to be used to implement the neural network, a set of tensors associated with the set of operations, and a set of memory resources on a particular target device that is to be used to implement the particular neural network, among other information. A collection of compilation passes may be performed using the intermediate representation. One or more of the compilation passes may be memory allocation compilation passes. Performing an example memory allocation pass may include determining 1670 attributes of each one of the tensors. A respective one of the memory resources may also be determined 1675 for allocation of a respective buffer for each one of the tensors based on the determined attributes of that tensor. The buffer for each tensor may be allocated 1680 in the corresponding memory resource determined for the tensor. Based on the results of the one or more memory allocation passes (and the other compilation passes), a binary executable may be generated 1685 that is tuned for the target computing device.

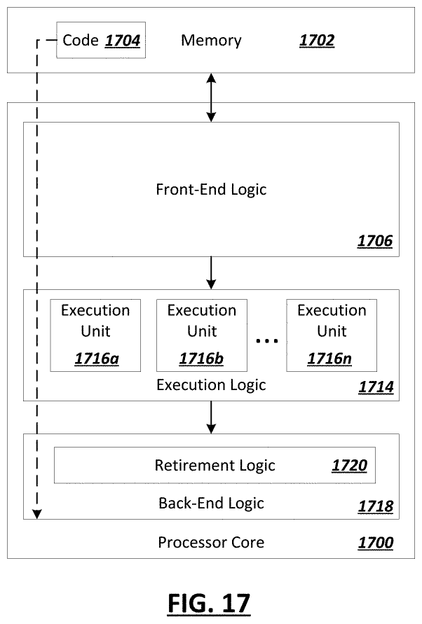

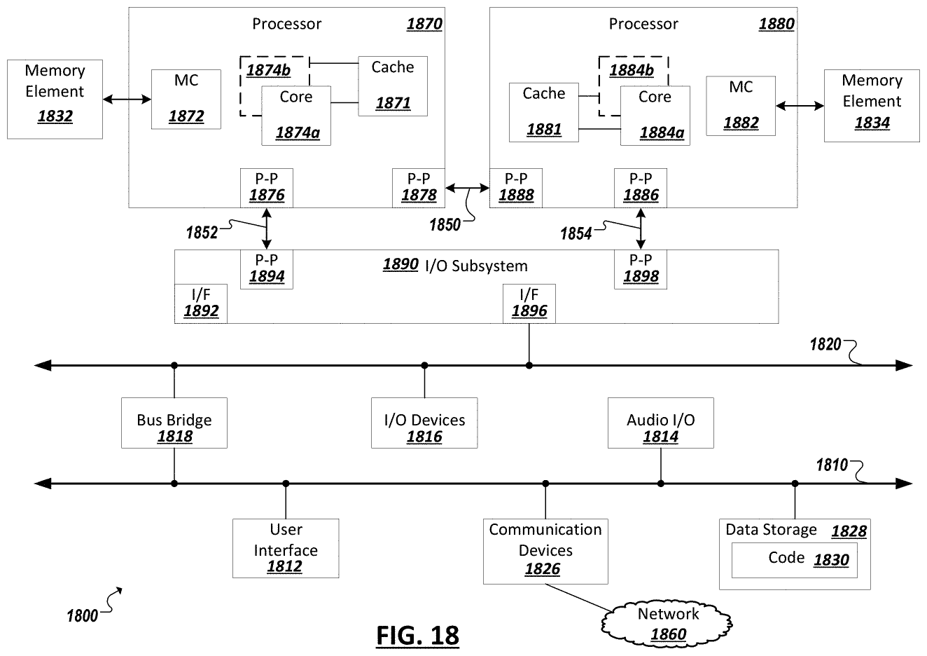

FIGS. 17-18 are block diagrams of exemplary computer architectures that may be used in accordance with embodiments disclosed herein. For instance, the computer architectures shown in these examples may be utilized to implement or execute an improved compiler and/or a portion of a target computing device. In other examples, the computer architectures shown in these examples may consume results generated by the neural network, provide data for use as inputs to the neural networks, among other cooperative uses. It should be appreciated that other computer architecture designs known in the art for processors and computing systems may also be used. Generally, suitable computer architectures for embodiments disclosed herein can include, but are not limited to, configurations illustrated in FIGS. 17-18.

FIG. 17 is an example illustration of a processor according to an embodiment. Processor 1700 is an example of a type of hardware device that can be used in connection with the implementations above. Processor 1700 may be any type of processor, such as a microprocessor, an embedded processor, a digital signal processor (DSP), a network processor, a multi-core processor, a single core processor, or other device to execute code. Although only one processor 1700 is illustrated in FIG. 17, a processing element may alternatively include more than one of processor 1700 illustrated in FIG. 17. Processor 1700 may be a single-threaded core or, for at least one embodiment, the processor 1700 may be multi-threaded in that it may include more than one hardware thread context (or “logical processor”) per core.

FIG. 17 also illustrates a memory 1702 coupled to processor 1700 in accordance with an embodiment. Memory 1702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1700 can execute any type of instructions associated with algorithms, processes, or operations detailed herein. Generally, processor 1700 can transform an element or an article (e.g., data) from one state or thing to another state or thing.

Code 1704, which may be one or more instructions to be executed by processor 1700, may be stored in memory 1702, or may be stored in software, hardware, firmware, or any suitable combination thereof, or in any other internal or external component, device, element, or object where appropriate and based on particular needs. In one example, processor 1700 can follow a program sequence of instructions indicated by code 1704. Each instruction enters a front-end logic 1706 and is processed by one or more decoders. The decoder may generate, as its output, a micro operation such as a fixed width micro operation in a predefined format, or may generate other instructions, microinstructions, or control signals that reflect the original code instruction. Front-end logic 1706 also includes register renaming logic 1710 and scheduling logic 1712, which generally allocate resources and queue the operation corresponding to the instruction for execution.

Processor 1700 can also include execution logic 1714 having a set of execution units 1716a, 1716b, 1716n, etc. Some embodiments may include a number of execution units dedicated to specific functions or sets of functions. Other embodiments may include only one execution unit or one execution unit that can perform a particular function. Execution logic 1714 performs the operations specified by code instructions.

After completion of execution of the operations specified by the code instructions, back-end logic 1718 can retire the instructions of code 1704. In one embodiment, processor 1700 allows out of order execution but requires in order retirement of instructions. Retirement logic 1720 may take a variety of known forms (e.g., re-order buffers or the like). In this manner, processor 1700 is transformed during execution of code 1704, at least in terms of the output generated by the decoder, hardware registers and tables utilized by register renaming logic 1710, and any registers (not shown) modified by execution logic 1714.

Although not shown in FIG. 17, a processing element may include other elements on a chip with processor 1700. For example, a processing element may include memory control logic along with processor 1700. The processing element may include I/O control logic and/or may include I/O control logic integrated with memory control logic. The processing element may also include one or more caches. In some embodiments, non-volatile memory (such as flash memory or fuses) may also be included on the chip with processor 1700.

FIG. 18 illustrates a computing system 1800 that is arranged in a point-to-point (PtP) configuration according to an embodiment. In particular, FIG. 18 shows a system where processors, memory, and input/output devices are interconnected by a number of point-to-point interfaces.

Processors 1870 and 1880 may also each include integrated memory controller logic (MC) 1872 and 1882 to communicate with memory elements 1832 and 1834. Example processors (e.g., 1870, 1880) may include one or more processor cores (e.g., 1874a-b, 1848a-b), which may be coupled to respective cache memory (e.g., 1871, 1882). In alternative embodiments, memory controller logic 1872 and 1882 may be discrete logic separate from processors 1870 and 1880. Memory elements 1832 and/or 1834 may store various data to be used by processors 1870 and 1880 in achieving operations and functionality outlined herein.

Processors 1870 and 1880 may be any type of processor, such as those discussed in connection with other figures. Processors 1870 and 1880 may exchange data via a point-to-point (PtP) interface 1850 using point-to-point interface circuits 1878 and 1888, respectively. Processors 1870 and 1880 may each exchange data with a chipset 1890 via individual point-to-point interfaces 1852 and 1854 using point-to-point interface circuits 1876, 1886, 1894, and 1898. Chipset 1890 may also exchange data with a co-processor 1838, such as a high-performance graphics circuit, machine learning accelerator, or other co-processor 1838, via an interface 1839, which could be a PtP interface circuit. In alternative embodiments, any or all of the PtP links illustrated in FIG. 18 could be implemented as a multi-drop bus rather than a PtP link.

Chipset 1890 may be in communication with a bus 1820 via an interface circuit 1896. Bus 1820 may have one or more devices that communicate over it, such as a bus bridge 1818 and I/O devices 1816. Via a bus 1810, bus bridge 1818 may be in communication with other devices such as a user interface 1812 (such as a keyboard, mouse, touchscreen, or other input devices), communication devices 1826 (such as modems, network interface devices, or other types of communication devices that may communicate through a computer network 1860), audio I/O devices 1814, and/or a data storage device 1828. Data storage device 1828 may store code 1830, which may be executed by processors 1870 and/or 1880. In alternative embodiments, any portions of the bus architectures could be implemented with one or more PtP links.

The computer system depicted in FIG. 18 is a schematic illustration of an embodiment of a computing system that may be utilized to implement various embodiments discussed herein. It will be appreciated that various components of the system depicted in FIG. 18 may be combined in a system-on-a-chip (SoC) architecture or in any other suitable configuration capable of achieving the functionality and features of examples and implementations provided herein.

While some of the systems and solutions described and illustrated herein have been described as containing or being associated with a plurality of elements, not all elements explicitly illustrated or described may be utilized in each alternative implementation of the present disclosure. Additionally, one or more of the elements described herein may be located external to a system, while in other instances, certain elements may be included within or as a portion of one or more of the other described elements, as well as other elements not described in the illustrated implementation. Further, certain elements may be combined with other components, as well as used for alternative or additional purposes in addition to those purposes described herein.

Further, it should be appreciated that the examples presented above are non-limiting examples provided merely for purposes of illustrating certain principles and features and not necessarily limiting or constraining the potential embodiments of the concepts described herein. For instance, a variety of different embodiments can be realized utilizing various combinations of the features and components described herein, including combinations realized through the various implementations of components described herein. Other implementations, features, and details should be appreciated from the contents of this Specification.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The following examples pertain to embodiments in accordance with this Specification. Example 1 is a machine-readable storage medium with instructions stored thereon, where the instructions are executable by a machine to cause the machine to: receive, at a compiler, a graph describing a neural network; access data to describe a target hardware device to implement the neural network; generate, at the compiler, from the graph and the data, an intermediate representation, where the intermediate representation includes an operator model to identify a set of operations to be performed to implement the neural network, a data model to identify a set of tensors corresponding to the set of operations, and a control model to identify a sequencing of the operations; and generate a binary executable using each of the operator model, data model, and control model of the intermediate representation.

Example 2 includes the subject matter of example 1, where the operator model identifies, from each node of the graph, a respective one of the set of operations, and further identifies, from each edge of the graph, a respective one of the set of tensors.

Example 3 includes the subject matter of any one of examples 1-2, where the data model identifies a set of buffers to be allocated in memory of the target hardware device and maps each of the set of tensors to a respective one of the set of buffers.

Example 4 includes the subject matter of any one of examples 1-3, where the control model identifies dependencies between the set of operations.

Example 5 includes the subject matter of any one of examples 1-4, where the data includes a target descriptor to identify memory and compute resources of the target hardware device.

Example 6 includes the subject matter of example 5, where the target hardware device includes two or more different types of compute resources and two or more different types of memory resources.

Example 7 includes the subject matter of example 6, where the target hardware device includes a hardware accelerator, one of the two or more different types of compute resources is implemented on the hardware accelerator and another one of the two or more different types of compute resources is implemented outside the hardware accelerator.

Example 8 includes the subject matter of any one of examples 6-7, where one of the two or more different types of memory resources includes local scratchpad memory and another one of the two or more different types of memory resources includes random access memory (RAM).

Example 9 includes the subject matter of any one of examples 1-8, where the instructions are further executable by a machine to cause the machine to perform a set of compilation passes using the operator model, data model, and control model to generate the binary executable.

Example 10 includes the subject matter of example 9, where performing the set of compilation passes includes: selecting, for each one of the set of compilation passes, one of the operator model, data model, or control model based on the respective compilation pass; and using the selected one of the operator model, data model, or control model to perform the corresponding compilation pass.

Example 11 includes the subject matter of example 10, where each of the operator model, data model, and control model include a respective graph, and one or more of the set of compilation passes includes a graph theory-based analysis of a corresponding one of the operator model, data model, or control model.

Example 12 includes the subject matter of example 9, where the instructions are further executable by a machine to cause the machine to receive a compilation descriptor to identify the set of compilation passes to be used by the compiler in generating the binary executable.

Example 13 includes the subject matter of any one of examples 1-12, where the executable binary includes serialized data to be provided to the target hardware device.

Example 14 includes the subject matter of any one of examples 1-13, where the executable binary is to optimize implementation of the neural network using resources of the target hardware device.

Example 15 is a method including: receiving, at a compiler, a graph describing a neural network; accessing data to describe a target hardware device to implement the neural network; generating, at the compiler, from the graph and the data, an intermediate representation, where the intermediate representation includes an operator model to identify a set of operations to be performed to implement the neural network, a data model to identify a set of tensors corresponding to the set of operations, and a control model to identify a sequencing of the operations; and generating a binary executable using each of the operator model, data model, and control model of the intermediate representation.

Example 16 includes the subject matter of example 15, further including performing a set of compilation passes using the intermediate representation to generate a translated version of the graph, where the binary executable is generated based on the translated version of the graph.

Example 17 includes the subject matter of example 16, where performing the set of compilation passes includes: selecting, for each one of the set of compilation passes, one of the operator model, data model, or control model based on the respective compilation pass; and using the selected one of the operator model, data model, or control model to perform the corresponding compilation pass.

Example 18 includes the subject matter of example 17, where each of the operator model, data model, and control model include a respective graph, and one or more of the set of compilation passes includes a graph theory-based analysis of a corresponding one of the operator model, data model, or control model.

Example 19 includes the subject matter of example 16, where the instructions are further executable by a machine to cause the machine to receive a compilation descriptor to identify the set of compilation passes to be used by the compiler in generating the binary executable.

Example 20 includes the subject matter of any one of examples 15-19, where the operator model identifies, from each node of the graph, a respective one of the set of operations, and further identifies, from each edge of the graph, a respective one of the set of tensors.

Example 21 includes the subject matter of any one of examples 15-20, where the data model identifies a set of buffers to be allocated in memory of the target hardware device and maps each of the set of tensors to a respective one of the set of buffers.

Example 22 includes the subject matter of any one of examples 15-21, where the control model identifies dependencies between the set of operations.

Example 23 includes the subject matter of any one of examples 15-22, where the data includes a target descriptor to identify memory and compute resources of the target hardware device.

Example 24 includes the subject matter of example 23, where the target hardware device includes two or more different types of compute resources and two or more different types of memory resources.

Example 25 includes the subject matter of example 24, where the target hardware device includes a hardware accelerator, one of the two or more different types of compute resources is implemented on the hardware accelerator and another one of the two or more different types of compute resources is implemented outside the hardware accelerator.

Example 26 includes the subject matter of any one of examples 24-25, where one of the two or more different types of memory resources includes local scratchpad memory and another one of the two or more different types of memory resources includes random access memory (RAM).

Example 27 includes the subject matter of any one of examples 15-26, where the executable binary includes serialized data to be provided to the target hardware device.

Example 28 includes the subject matter of any one of examples 15-27, where the executable binary is to optimize implementation of the neural network using resources of the target hardware device.

Example 29 is a system including means to perform the method of any one of examples 15-28,

Example 30 includes the subject matter of example 29, where the means include a compiler program executable by a data processor.

Example 31 is a system including: a data processor; a memory; and a compiler, executable by the data processor to: receive a graph describing a neural network; access data to describe a target hardware device to implement the neural network; generate from the graph and the data, an intermediate representation, where the intermediate representation includes an operator model to identify a set of operations to be performed to implement the neural network, a data model to identify a set of tensors corresponding to the set of operations, and a control model to identify a sequencing of the operations; and generate a binary executable using each of the operator model, data model, and control model of the intermediate representation.

Example 32 includes the subject matter of example 31, where the compiler is further to: access second data to describe a second, different target hardware device to implement the neural network; generate from an instance of the graph and the second data, a second intermediate representation, where the second intermediate representation includes a respective operator model, data model, and control model, where the second intermediate representation is different from the intermediate representation; and generate a second binary executable using the second intermediate representation, where the second binary executable is different from the binary executable.

Example 33 includes the subject matter of example 31, where the data includes a target descriptor file identifying attributes of a set of memory resources of a target computing device, the compiler is further to: receive the target descriptor as an input, where the intermediate representation is generated based on the attributes; receive a compilation descriptor identifying a plurality of compilation passes; and perform the plurality of compilation passes based on the compilation descriptor to generate the binary executable.

Example 34 includes the subject matter of example 31, where the compiler is perform a plurality of compilation passes to generate the binary executable, and the plurality of compilation passes includes a memory allocation pass, and performing the memory allocation pass includes: determining, for a particular one of the set of tensors, attributes of the particular tensor; determining, for the particular tensor, that the particular tensor is to be stored in a particular one of the set of memory resources based on one or more of the attributes; and allocate a particular buffer for the particular tensor in the particular memory resource based on one or more of the attributes, where the target computing device, when executing the binary executable, is to use the particular buffer to store the particular tensor.

Example 35 is a machine-readable storage medium with instructions stored thereon, where the instructions are executable by a machine to cause the machine to: receive, at a compiler, a graph describing a neural network; receive, at the compiler, a target descriptor identifying attributes of a set of memory resources of a target computing device; receive, at the compiler, a compilation descriptor identifying a plurality of compilation passes; generate, at the compiler, an intermediate representation based on the target descriptor and the graph; perform the plurality of compilation passes, using the complier, based on the compilation descriptor; and generate, from the plurality of compilation passes, a binary executable to implement the neural network on the target computing device.

Example 36 includes the subject matter of example 35, where the intermediate representation identifies a set of operations and a set of tensors

Example 37 includes the subject matter of example 36, where at least one of the plurality of compilation passes determines a set of buffers to allocate in the set of memory resources to store one or more tensors associated with one or more operations.

Example 38 includes the subject matter of example 37, where the intermediate representation is generated to include a set of memory allocator objects and the set of memory allocator objects are used to allocate the set of buffers.

Example 39 includes the subject matter of example 38, where a respective memory allocator object is to be created, by the compiler, for each one of the set of memory resources.

Example 40 includes the subject matter of any one of examples 35-39, where the plurality of compilation passes includes one or more memory allocation passes to allocate memory to implement the set of buffers based on a memory allocation algorithm.

Example 41 includes the subject matter of example 40, where the memory allocation algorithm is identified in the compilation descriptor.

Example 42 includes the subject matter of example 41, where the memory allocation algorithm includes a particular one of a plurality of memory allocation algorithms supported by the compiler.

Example 43 includes the subject matter of any one of examples 36-42, where the target descriptor further identifies attributes of a plurality of compute resources of the target computing device, at least one of the plurality of compilation passes determines, for each of the set of operations, one of the set of plurality of compute resources to perform the respective operation.

Example 44 includes the subject matter of any one of examples 35-43, where the instructions are further executable to cause the machine to: generate a first data structure to identify the memory resources of the target computing device; and generate a second data structure to identify the plurality of compilation passes.

Example 45 includes the subject matter of any one of examples 35-44, where the plurality of compilation passes includes a particular compilation pass specific to features of the target computing device.

Example 46 includes the subject matter of any one of examples 35-45, where the target computing device includes heterogeneous memory resources.

Example 47 includes the subject matter of any one of examples 35-46, where the executable binary includes serialized data to be provided to the target computing device.

Example 48 includes the subject matter of any one of examples 35-47, where the executable binary is to optimize implementation of the neural network using resources of the target computing device.

Example 49 is a method including: receiving, at a compiler, a graph describing a neural network; receiving, at the compiler, a target descriptor identifying attributes of a set of memory resources of a target computing device; receiving, at the compiler, a compilation descriptor identifying a plurality of compilation passes; generating, at the compiler, an intermediate representation based on the target descriptor and the graph; performing the plurality of compilation passes, using the complier, based on the compilation descriptor; and generating, from the plurality of compilation passes, a binary executable to implement the neural network on the target computing device.

Example 50 includes the subject matter of example 49, where the intermediate representation identifies a set of operations and a set of tensors

Example 51 includes the subject matter of example 50, where at least one of the plurality of compilation passes determines a set of buffers to allocate in the set of memory resources to store one or more tensors associated with one or more operations.

Example 52 includes the subject matter of example 51, where the intermediate representation is generated to include a set of memory allocator objects and the set of memory allocator objects are used to allocate the set of buffers.

Example 53 includes the subject matter of example 52, where a respective memory allocator object is to be created, by the compiler, for each one of the set of memory resources.

Example 54 includes the subject matter of any one of examples 49-53, where the plurality of compilation passes includes one or more memory allocation passes to allocate memory to implement the set of buffers based on a memory allocation algorithm.

Example 55 includes the subject matter of example 54, where the memory allocation algorithm is identified in the compilation descriptor.

Example 56 includes the subject matter of example 55, where the memory allocation algorithm includes a particular one of a plurality of memory allocation algorithms supported by the compiler.

Example 57 includes the subject matter of any one of examples 40-56, where the target descriptor further identifies attributes of a plurality of compute resources of the target computing device, at least one of the plurality of compilation passes determines, for each of the set of operations, one of the set of plurality of compute resources to perform the respective operation.

Example 58 includes the subject matter of any one of examples 49-57, where the instructions are further executable to cause the machine to: generate a first data structure to identify the memory resources of the target computing device; and generate a second data structure to identify the plurality of compilation passes.

Example 59 includes the subject matter of any one of examples 49-58, where the plurality of compilation passes includes a particular compilation pass specific to features of the target computing device.

Example 60 includes the subject matter of any one of examples 49-59, where the target computing device includes heterogeneous memory resources.

Example 61 includes the subject matter of any one of examples 49-60, where the executable binary includes serialized data to be provided to the target computing device.

Example 62 includes the subject matter of any one of examples 49-61, where the executable binary is to optimize implementation of the neural network using resources of the target computing device.

Example 63 is a system including means to perform the method of any one of examples 49-62.

Example 64 includes the subject matter of example 63, where the means include a compiler program executable by a data processor.

Example 65 is a system including: a data processor; a memory; and a compiler, executable by the data processor to: receive a graph describing a neural network; receive a target descriptor identifying attributes of a set of memory resources of a target computing device; receive a compilation descriptor identifying a plurality of compilation passes; generate an intermediate representation based on the target descriptor and the graph; perform the plurality of compilation passes, using the complier, based on the compilation descriptor; and generate a binary executable to implement the neural network on the target computing device.

Example 66 includes the subject matter of example 65, where the target descriptor further identifies a set of compute resources of the target computing device.

Example 67 includes the subject matter of example 65, where the compiler is further to create a respective instance of a memory allocator object for each one of the set of memory resources, and the memory allocator object is used by the compiled to allocate buffers in the set of memory resources.

Example 68 includes the subject matter of example 65, where the intermediate representation includes an operator model to identify a set of operations to be performed to implement the neural network, a data model to identify a set of tensors corresponding to the set of operations, and a control model to identify a sequencing of the operations.

Example 69 includes the subject matter of example 65, where the plurality of compilation passes includes a memory allocation pass, and performing the memory allocation pass includes: determining, for a particular one of a set of tensors, attributes of the particular tensor; determining, for the particular tensor, that the particular tensor is to be stored in a particular one of the set of memory resources based on one or more of the attributes; and allocate a particular buffer for the particular tensor in the particular memory resource based on one or more of the attributes, where the target computing device, when executing the binary executable, is to use the particular buffer to store the particular tensor.

Example 70 is a machine-readable storage medium with instructions stored thereon, where the instructions are executable by a machine to cause the machine to: receive, at a compiler, a graph describing a neural network; generate an intermediate representation based on the graph, where the intermediate representation identifies: a set of operations to be performed to implement the neural network, a set of tensors associated with the set of operations, and a set of memory resources on a particular computing device; and perform a set of compilation passes using the intermediate representation to generate a binary executable for the particular computing device. The set of compilation passes includes a memory allocation pass and performing the memory allocation pass includes: determining, for a particular one of the set of tensors, attributes of the particular tensor; determining, for the particular tensor, that the particular tensor is to be stored in a particular one of the set of memory resources based on one or more of the attributes; and allocate a particular buffer for the particular tensor in the particular memory resource based on one or more of the attributes, where the particular computing device, when executing the binary executable, is to use the particular buffer to store the particular tensor.

Example 71 includes the subject matter of example 70, where the one or more attributes include a type of tensor, and the type of tensor includes one of a populated tensor or an unpopulated tensor.

Example 72 includes the subject matter of example 71, where the particular buffer is to be allocated in local scratchpad memory when the particular tensor includes an unpopulated tensor.

Example 73 includes the subject matter of example 71, where the particular buffer is to be allocated in off-chip memory when the particular tensor includes a populated tensor.

Example 74 includes the subject matter of any one of examples 70-73, where the one or more attributes include a size of the tensor.

Example 75 includes the subject matter of any one of examples 70-74, where the one or more attributes include padding of the tensor.

Example 76 includes the subject matter of any one of examples 70-75, where the memory allocation pass further includes traversing a graph representation of the set of tensors in the intermediate representation, and a respective buffer is to be allocated for each one of the set of tensors in the memory allocation pass.

Example 77 includes the subject matter of any one of examples 70-76, where a subset of the set of compilation passes is to be performed prior to performance of the memory allocation pass, where the subset of compilation passes assign compute resources of the particular computing resources to perform the set of operations and establishes an order of the set of operations.

Example 78 includes the subject matter of example 77, where the subset of compilation passes includes one or more adaptation passes to determine hardware-agnostic optimizations to the graph.

Example 79 includes the subject matter of example 78, where the one or more adaptation passes perform at least one of operator fusion or operator replacement.

Example 80 includes the subject matter of any one of examples 78-79, where the adaptation passes changes the number of the set of tensors from an original number determined from the graph.

Example 81 includes the subject matter of any one of examples 70-80, where generating the intermediate representation includes creating a set of memory allocator objects for the set of memory resources, and the set of memory allocator objects are used in the memory allocation pass.

Example 82 includes the subject matter of example 81, where a respective memory allocator object is created for each one of the set of memory resources.

Example 83 includes the subject matter of any one of examples 81-82, where each one of the set of memory allocator objects includes a set of methods executable through the compiler to determine a set of attributes of the corresponding memory resource.

Example 84 includes the subject matter of any one of examples 70-83, where the intermediate representation includes an operator model including a graph to identify the set of operations and the set of tensors.

Example 85 includes the subject matter of any one of examples 70-84, where the instructions are further executable to cause the machine to receive a target descriptor to identify attribute of the set of memory resources of the particular computing device and further identify a set of compute resources of the particular computing device.

Example 86 includes the subject matter of example 85, where the set of compute resources of the particular computing device includes resources in a set of particular processor devices on the particular computing device and further includes resources of a machine learning accelerator device on the particular computing device.

Example 87 includes the subject matter of example 85-86, where the set of memory resources include heterogeneous memory resources.

Example 88 includes the subject matter of any one of examples 85-87, where another one of the compilation passes is to determine, for each of the set of operations, which operation is to be performed by which one of the set of compute resources.

Example 89 includes the subject matter of any one of examples 70-88, where the instructions are further executable to cause the machine to receive a compilation descriptor to indicate the set of compilation passes to be performed to generate the binary executable.

Example 90 includes the subject matter of example 89, where the compilation descriptor identifies a particular memory allocation algorithm, and the particular memory allocation algorithm is to be applied in the memory allocation pass based on the compilation descriptor.

Example 91 includes the subject matter of any one of examples 89-90, where the set of compilation passes includes a particular compilation pass specific to features of the target computing device.

Example 92 includes the subject matter of any one of examples 70-91, where the executable binary includes serialized data to be provided to the particular computing device.

Example 93 includes the subject matter of any one of examples 70-92, where the executable binary is to optimize implementation of the neural network using resources of the particular computing device.

Example 94 is a method including: receiving, at a compiler, a graph describing a neural network; generating an intermediate representation based on the graph, where the intermediate representation identifies: a set of operations to be performed to implement the neural network, a set of tensors associated with the set of operations, and a set of memory resources on a particular computing device; and performing a set of compilation passes using the intermediate representation to generate a binary executable for the particular computing device. The set of compilation passes includes a memory allocation pass and performing the memory allocation pass includes: determining, for a particular one of the set of tensors, attributes of the particular tensor; determining, for the particular tensor, that the particular tensor is to be stored in a particular one of the set of memory resources based on one or more of the attributes; and allocate a particular buffer for the particular tensor in the particular memory resource based on one or more of the attributes, where the particular computing device, when executing the binary executable, is to use the particular buffer to store the particular tensor.

Example 95 includes the subject matter of example 94, where the one or more attributes include a type of tensor, and the type of tensor includes one of a populated tensor or an unpopulated tensor.

Example 96 includes the subject matter of example 95, where the particular buffer is to be allocated in local scratchpad memory when the particular tensor includes an unpopulated tensor.

Example 97 includes the subject matter of example 95, where the particular buffer is to be allocated in off-chip memory when the particular tensor includes a populated tensor.

Example 98 includes the subject matter of any one of examples 94-97, where the one or more attributes include a size of the tensor.

Example 99 includes the subject matter of any one of examples 94-98, where the one or more attributes include padding of the tensor.

Example 100 includes the subject matter of any one of examples 94-99, where the memory allocation pass further includes traversing a graph representation of the set of tensors in the intermediate representation, and a respective buffer is to be allocated for each one of the set of tensors in the memory allocation pass.

Example 101 includes the subject matter of any one of examples 94-100, where a subset of the set of compilation passes is to be performed prior to performance of the memory allocation pass, where the subset of compilation passes assign compute resources of the particular computing resources to perform the set of operations and establishes an order of the set of operations.

Example 102 includes the subject matter of example 101, where the subset of compilation passes includes one or more adaptation passes to determine hardware-agnostic optimizations to the graph.

Example 103 includes the subject matter of example 102, where the one or more adaptation passes perform at least one of operator fusion or operator replacement.

Example 104 includes the subject matter of any one of examples 102-103, where the adaptation passes changes the number of the set of tensors from an original number determined from the graph.

Example 105 includes the subject matter of any one of examples 94-104, where generating the intermediate representation includes creating a set of memory allocator objects for the set of memory resources, and the set of memory allocator objects are used in the memory allocation pass.

Example 106 includes the subject matter of example 105, where a respective memory allocator object is created for each one of the set of memory resources.

Example 107 includes the subject matter of any one of examples 105-106, where each one of the set of memory allocator objects includes a set of methods executable through the compiler to determine a set of attributes of the corresponding memory resource.

Example 108 includes the subject matter of any one of examples 94-107, where the intermediate representation includes an operator model including a graph to identify the set of operations and the set of tensors.

Example 109 includes the subject matter of any one of examples 94-108, where the instructions are further executable to cause the machine to receive a target descriptor to identify attribute of the set of memory resources of the particular computing device and further identify a set of compute resources of the particular computing device.

Example 110 includes the subject matter of example 109, where the set of compute resources of the particular computing device includes resources in a set of particular processor devices on the particular computing device and further includes resources of a machine learning accelerator device on the particular computing device.

Example 111 includes the subject matter of example 109-110, where the set of memory resources include heterogeneous memory resources.

Example 112 includes the subject matter of any one of examples 109-111, where another one of the compilation passes is to determine, for each of the set of operations, which operation is to be performed by which one of the set of compute resources.

Example 113 includes the subject matter of any one of examples 94-112, where the instructions are further executable to cause the machine to receive a compilation descriptor to indicate the set of compilation passes to be performed to generate the binary executable.

Example 114 includes the subject matter of example 113, where the compilation descriptor identifies a particular memory allocation algorithm, and the particular memory allocation algorithm is to be applied in the memory allocation pass based on the compilation descriptor.

Example 115 includes the subject matter of any one of examples 113-114, where the set of compilation passes includes a particular compilation pass specific to features of the target computing device.

Example 116 includes the subject matter of any one of examples 94-115, where the executable binary includes serialized data to be provided to the particular computing device.

Example 117 includes the subject matter of any one of examples 94-116, where the executable binary is to optimize implementation of the neural network using resources of the particular computing device.

Example 118 is a system including means to perform the method of any one of examples 94-117.

Example 119 includes the subject matter of example 118, where the means include a compiler program executable by a data processor.

Example 120 is a system including: a data processor; a memory; and a compiler, executable by the data processor to: receive, at a compiler, a graph describing a neural network; generate an intermediate representation based on the graph, where the intermediate representation identifies: a set of operations to be performed to implement the neural network, a set of tensors associated with the set of operations, and a set of memory resources on a particular computing device; and perform a set of compilation passes using the intermediate representation to generate a binary executable for the particular computing device. The set of compilation passes includes a memory allocation pass and performing the memory allocation pass includes: determining, for a particular one of the set of tensors, attributes of the particular tensor; determining, for the particular tensor, that the particular tensor is to be stored in a particular one of the set of memory resources based on one or more of the attributes; and allocate a particular buffer for the particular tensor in the particular memory resource based on one or more of the attributes, where the particular computing device, when executing the binary executable, is to use the particular buffer to store the particular tensor.

Example 121 includes the subject matter of example 120, where the compiler is further to initialize a set of memory allocators for the set of memory resources to be used during the memory allocation pass.

Example 122 includes the subject matter of example 120, where the particular buffer is to be allocated in local scratchpad memory when the particular tensor includes an unpopulated tensor and allocated in off-chip memory when the particular tensor includes a populated tensor.

Example 123 includes the subject matter of example 120, where the intermediate representation includes an operator model to identify the set of operations to be performed to implement the neural network, a data model to identify the set of tensors corresponding to the set of operations, and a control model to identify a sequencing of the set of operations.

Example 124 includes the subject matter of example 120, where the compiler is further to: receive a target descriptor as an input, where the target descriptor identifies attributes of the set of memory resources, and the intermediate representation is generated based on the attributes; and receive a compilation descriptor defining the set of compilation passes.

Example 125 is a compiler executable to perform the method of any one of examples 15-28, 49-62, 94-117.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine-readable storage medium with instructions stored thereon, wherein the instructions are executable by a machine to cause the machine to:
receive, at a compiler, a graph describing a neural network;
access data to describe a target hardware device to implement the neural network;
generate, at the compiler, from the graph and the data, an intermediate representation, wherein the intermediate representation comprises an operator model to identify a set of operations to be performed to implement the neural network, a data model to identify a set of tensors corresponding to the set of operations, and a control model to identify a sequencing of the operations; and
generate a binary executable using each of the operator model, data model, and control model of the intermediate representation.

2. The storage medium of claim 1, wherein the operator model identifies, from each node of the graph, a respective one of the set of operations, and further identifies, from each edge of the graph, a respective one of the set of tensors.

3. The storage medium of claim 1, wherein the data model identifies a set of buffers to be allocated in memory of the target hardware device and maps each of the set of tensors to a respective one of the set of buffers.

4. The storage medium of claim 1, wherein the control model identifies dependencies between the set of operations.

5. The storage medium of claim 1, wherein the data comprises a target descriptor to identify memory and compute resources of the target hardware device.

6. The storage medium of claim 5, wherein the target hardware device comprises two or more different types of compute resources and two or more different types of memory resources.

7. The storage medium of claim 6, wherein the target hardware device comprises a hardware accelerator, one of the two or more different types of compute resources is implemented on the hardware accelerator and another one of the two or more different types of compute resources is implemented outside the hardware accelerator.

8. The storage medium of claim 6, wherein one of the two or more different types of memory resources comprises local scratchpad memory and another one of the two or more different types of memory resources comprises random access memory (RAM).

9. The storage medium of claim 1, wherein the instructions are further executable by a machine to cause the machine to perform a set of compilation passes using the operator model, data model, and control model to generate the binary executable.

10. The storage medium of claim 9, wherein performing the set of compilation passes comprises:
selecting, for each one of the set of compilation passes, one of the operator model, data model, or control model based on the respective compilation pass; and
using the selected one of the operator model, data model, or control model to perform the corresponding compilation pass.

11. The storage medium of claim 10, wherein each of the operator model, data model, and control model comprise a respective graph, and one or more of the set of compilation passes comprises a graph theory-based analysis of a corresponding one of the operator model, data model, or control model.

12. The storage medium of claim 9, wherein the instructions are further executable by a machine to cause the machine to receive a compilation descriptor to identify the set of compilation passes to be used by the compiler in generating the binary executable.

13. The storage medium of claim 1, wherein the executable binary comprises serialized data to be provided to the target hardware device.

14. The storage medium of claim 1, wherein the executable binary is to optimize implementation of the neural network using resources of the target hardware device.

15. A method comprising:
receiving, at a compiler, a graph describing a neural network;
accessing data to describe a target hardware device to implement the neural network;
generating, at the compiler, from the graph and the data, an intermediate representation, wherein the intermediate representation comprises an operator model to identify a set of operations to be performed to implement the neural network, a data model to identify a set of tensors corresponding to the set of operations, and a control model to identify a sequencing of the operations; and
generating a binary executable using each of the operator model, data model, and control model of the intermediate representation.

16. The method of claim 15, further comprising performing a set of compilation passes using the intermediate representation to generate a translated version of the graph, wherein the binary executable is generated based on the translated version of the graph.

17. A system comprising:
a data processor;
a memory; and
a compiler, executable by the data processor to:
receive a graph describing a neural network;
access data to describe a target hardware device to implement the neural network;
generate from the graph and the data, an intermediate representation, wherein the intermediate representation comprises an operator model to identify a set of operations to be performed to implement the neural network, a data model to identify a set of tensors corresponding to the set of operations, and a control model to identify a sequencing of the operations; and
generate a binary executable using each of the operator model, data model, and control model of the intermediate representation.

18. The system of claim 17, wherein the compiler is further to:
access second data to describe a second, different target hardware device to implement the neural network;
generate from an instance of the graph and the second data, a second intermediate representation, wherein the second intermediate representation comprises a respective operator model, data model, and control model, wherein the second intermediate representation is different from the intermediate representation; and
generate a second binary executable using the second intermediate representation, wherein the second binary executable is different from the binary executable.

19. The system of claim 17, wherein the data comprises a target descriptor file identifying attributes of a set of memory resources of a target computing device, the compiler is further to:
receive the target descriptor as an input, wherein the intermediate representation is generated based on the attributes;
receive a compilation descriptor identifying a plurality of compilation passes;
perform the plurality of compilation passes based on the compilation descriptor to generate the binary executable.

20. The system of claim 17, wherein the compiler is perform a plurality of compilation passes to generate the binary executable, and the plurality of compilation passes comprises a memory allocation pass, and performing the memory allocation pass comprises:
determining, for a particular one of the set of tensors, attributes of the particular tensor;
determining, for the particular tensor, that the particular tensor is to be stored in a particular one of the set of memory resources based on one or more of the attributes; and
allocate a particular buffer for the particular tensor in the particular memory resource based on one or more of the attributes, wherein the target computing device, when executing the binary executable, is to use the particular buffer to store the particular tensor.
